(19) United States
(12) Patent Application Publication
(10) Pub. No.: US 2018/0288461 A1
(43) Pub. Date: Oct. 4, 2018

(54) Web Analytics for Video Level Events

(71) Applicants: Gregory Allan Funk, San Francisco, CA (US); Nareshkumar Rajkumar, San Jose, CA (US); Vincent Gatto, JR., San Francisco, CA (US); Theodore Kent Hamilton, Kusnacht (CH)

(72) Inventors: Gregory Allan Funk, San Francisco, CA (US); Nareshkumar Rajkumar, San Jose, CA (US); Vincent Gatto, JR., San Francisco, CA (US); Theodore Kent Hamilton, Kusnacht (CH)

(73) Assignee: GOOGLE INC., Mountain View, CA (US)

(21) Appl. No.: 13/529,114

(22) Filed: Jun. 21, 2012

(51) Int. Cl. H04N 21/27; H04N 19/10

(52) U.S. Cl. CPC H04N 21/27; H04N 19/10

(57) ABSTRACT

A system and method for providing web analytics describing video level events. The system includes a communication module, a request analysis module and an analytics module. The communication module receives a request including a unique video identifier (video ID), a video version identifier and event data. The event data describes a video level event and is associated with the video ID and the video version identifier. The request analysis module receives the request from the communication module. The request analysis module analyzes the request to determine if the request includes the event data. The analytics module is configured to determine values for metrics describing the video level event. Based at least in part on a determination by the request analysis module that the request includes event data, the analytics module receives the request from the request analysis module and analyzes the event data to determine a value for the metric.

### BACKGROUND

The present disclosure generally relates to web analytics and, more specifically, web analytics for video level events.

Entities that publish content, such as videos, to one or more websites typically desire analytic data about the published content. For example, if video data is published to one or more websites, the publishers may seek information about the number of times the video data is viewed, if the video data is functioning as an advertisement, the number of users watching the video data or other metrics describing performance of the video data. Such video data metrics may allow a publisher to identify problems with the video data or with the web sites used to present the video data, allowing the publisher to modify the video data or where the video data is presented to increase user interaction with the video data. With video data becoming an increasingly larger portion of Internet traffic, metrics describing video data allow publishers to more effectively disseminate video data.

Because users view video data in the context of viewing a web page included in the website, publishers also have concern over the website and/or web page where video data is viewed. Because of the relationship between video data and website or web pages, if a publisher views only video data metrics, the publisher would have an incomplete understanding of user activity and user experience with the website. Additionally, user interaction with web pages is important for understanding the performance of the video data. For example, data describing whether users stay on a website longer when viewing particular video data allows a publisher to determine whether certain video data attracts a user to continue accessing web pages within a website or causes users to exit the website after viewing the video data.

### SUMMARY

Embodiments disclosed herein provide a system and method for providing web analytics for video level events. In one embodiment, a system includes a communication module, a request analysis module and an analytics module. The communication module receives a request including a unique video identifier (video ID), a video version identifier and event data. The event data describes a video level event and is associated with the video ID and the video version identifier.

The request analysis module receives the request from the communication module. The request analysis module analyzes the request to determine if the request includes the event data.

The analytics module is configured to determine values for metrics describing the video level event. Based at least in part on a determination by the request analysis module that the request includes event data, the analytics module receives the request from the request analysis module and analyzes the event data to determine a value for a metric.

The features and advantages described herein are not all-inclusive and many additional features and advantages will be apparent to one of ordinary skill in the art in view of the figures and description. Moreover, it should be noted that the language used in the specification has been principally selected for readability and instructional purposes, and not to limit the scope of the subject matter disclosed herein.

### BRIEF DESCRIPTION OF THE DRAWINGS

Embodiments are illustrated by way of example, and not by way of limitation in the figures of the accompanying drawings in which like reference numerals are used to refer to similar elements.

FIG. 1 is a block diagram of one embodiment of a computing environment for providing web analytics for video level events in accordance with one embodiment.

FIG. 2 is a block diagram illustrating one embodiment of a user device.

FIG. 3A is a block diagram illustrating one embodiment of a content management system.

FIG. 3B is a block diagram illustrating one embodiment of a content management module.

FIG. 4 is a block diagram illustrating one embodiment of an analytics server.

FIG. 5 is a block diagram illustrating one embodiment of an analytics store.

FIGS. 6A-6C are event diagrams illustrating various embodiments of events for providing web analytics for video level events.

FIG. 7 is an event diagram illustrating one embodiment of a method for transmitting video level event data.

FIG. 8 a flow chart illustrating one embodiment of a method for determining whether a media player cookie matches a web page tracking cookie.

FIGS. 9A-9D are flow charts illustrating one embodiment of a method for providing web analytics for video level events.

FIG. 10 is a flow chart illustrating one embodiment of a method for analyzing event data describing video level events.

FIG. 11 is a flow chart illustrating one embodiment of a method of generating a report.

### DETAILED DESCRIPTION

A system for detecting and analyzing video level events is described below. In the following description, for purposes of explanation, numerous specific details are set forth to provide a thorough understanding of the various embodiments. However, it will be apparent to one skilled in the art that the various embodiments can be practiced without these specific details. In other instances, structures and devices are shown in block diagram form in order to avoid obscuring the certain details. For example, an embodiment is described below with reference to user interfaces and particular hardware. However, other embodiments can be described with reference to any type of computing device that can receive data and commands, and any peripheral devices providing services.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some portions of the following detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The present embodiments also relate to an apparatus for performing the operations herein. This apparatus may be specially constructed for the required purposes, or it may be a general-purpose computer selectively activated or reconfigured by a computer program stored in the computer. The embodiments disclosed may take the form of an entirely hardware embodiment, an entirely software embodiment or an embodiment including both hardware and software elements. One embodiment is implemented in software comprising instructions or data stored on a computer-readable storage medium, which includes but is not limited to firmware, resident software, microcode or another method for storing instructions for execution by a processor.

Furthermore, the embodiments may take the form of a computer program product accessible from a computer-usable or computer-readable storage medium providing program code for use by, or in connection with, a computer or any instruction execution system. For the purposes of this description, a computer-usable or computer readable storage medium is any apparatus that can contain, store or transport the program for use by or in connection with the instruction execution system, apparatus or device. The computer-readable storage medium can be an electronic, magnetic, optical, electromagnetic, infrared, or semiconductor system (or apparatus or device) or a propagation medium. Examples of a tangible computer-readable storage medium include a semiconductor or solid state memory, magnetic tape, a removable computer diskette, a random access memory (RAM), a read-only memory (ROM), a rigid magnetic disk, an optical disk, an EPROM, an EEPROM, a magnetic card or an optical card. Examples of optical disks include compact disk-read only memory (CD-ROM), compact disk-read/write (CD-R/W) and digital video disc (DVD).

Embodiments of the system described herein are suitable for storing and/or executing program code includes at least one processor coupled directly or indirectly to memory elements through a system bus. The memory elements may include local memory employed during actual execution of the program code, bulk storage and cache memories providing temporary storage of at least some program code in order to reduce the number of times code must be retrieved from bulk storage during execution. In some embodiments, input/output (I/O) devices (such as keyboards, displays, pointing devices or other devices configured to receive data or to present data) are coupled to the system either directly or through intervening I/O controllers.

Network adapters may also be coupled to the data processing system to allow coupling to other data processing systems or remote printers or storage devices through intervening private or public networks. Modems, cable modem and Ethernet cards are just examples of the currently available types of network adapters.

Finally, the algorithms and displays presented herein are not inherently related to any particular computer or other apparatus. Various general-purpose systems may be used with programs in accordance with the disclosure herein, or it may prove convenient to construct more specialized apparatus to perform the required method steps. The required structure for a variety of these systems will appear from the description below. It will be appreciated that a variety of programming languages may be used to implement the disclosure of the embodiments as described herein.

### System Overview

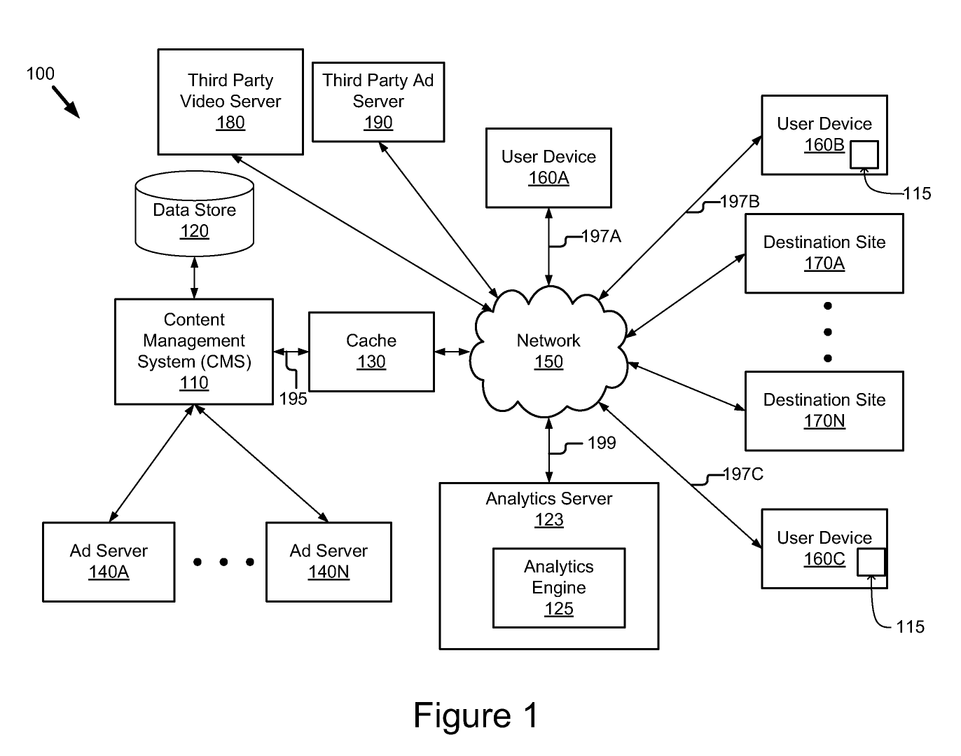

FIG. 1 shows an embodiment of a system 100 for capturing and analyzing video level events. In the embodiment depicted by FIG. 1, the system 100 includes a content management system (CMS) 110, a data store 120, an analytics server 123 that includes an analytics engine 125, a cache 130, one or more advertisement servers (“ad servers”) 140A-140N (also referred to individually and collectively as 140), a network 150, a third party video server 180, a third party ad server 190, one or more user devices 160A, 160B, 160C (also referred to individually and collectively as 160) and one or more destination sites 170A-170N (also referred to individually and collectively as 170). Additionally, FIG. 1 also illustrates a media player 115 operating on one or more user devices 160. However, in other embodiments, the system 100 may include different and/or additional components other than those depicted by FIG. 1.

The components of the system 100 are communicatively coupled to one another. For example, the analytics server 123 is communicatively coupled to the network 150 via signal line 199. The CMS 110 is communicatively coupled to the cache 130 via signal line 195. The user device 160A is communicatively coupled to the network 150 via signal line 197A. The user device 160B is communicatively coupled to the network 150 via signal line 197B. The user device 160C is communicatively coupled to the network 150 via signal line 197C.

The CMS 110 includes one or more processors and one or more storage devices storing data or instructions for execution by the one or more processors. For example, the CMS 110 is a server, a server array or any other computing device, or group of computing devices, having data processing and communication capabilities. The CMS 110 receives video data and metadata from one or more publishers operating on one or more user devices 160 or other sources. A publisher is a user that publishes a video on one or more of the CMS 110, the third party video server 180 and the destination site 170. For example, a publisher is an owner of a video. The CMS 110 associates the metadata with the video data and communicates the metadata, video data and association between video data and metadata to the data store 120, allowing the data store 120 to maintain relationships between video data and the metadata. Additionally, the CMS 110 receives requests for stored video data from a user device 160 and retrieves video data and metadata associated with the stored video data from the data store 120.

In one embodiment, the CMS 110 generates data or instructions for generating a media player 115 used to present the video data when executed by a processor. For example, the CMS 110 generates “embed code” that is included in a web page so that a media player 115 is embedded in the web page when loading the web page in a browser. The CMS 110 generates the data for creating a media player 115 (e.g., embed code) based at least in part on the video data and the metadata associated with the video data. In another embodiment, the analytics server 123 generates data or instructions for generating the media player 115. The analytics server 123 is described in further detail below.

In one embodiment, the media player 115 is not generated based on data or instructions generated by the analytics server 123. For example, the media player 115 is code and routines stored on the user device 160. A processor of the user device 160 executes the media player 115. A browser (not pictured) stored and executed by the user device 160 receives video data from the CMS 110 via the network 150. The media player 115 receives the video data from the browser and displays a video on a display (not pictured) communicatively coupled to the user device 160. Optionally, the media player 115 includes extensible metadata that can be modified by a user to change the features of the media player 115. The media player 115 is described in more detail below.

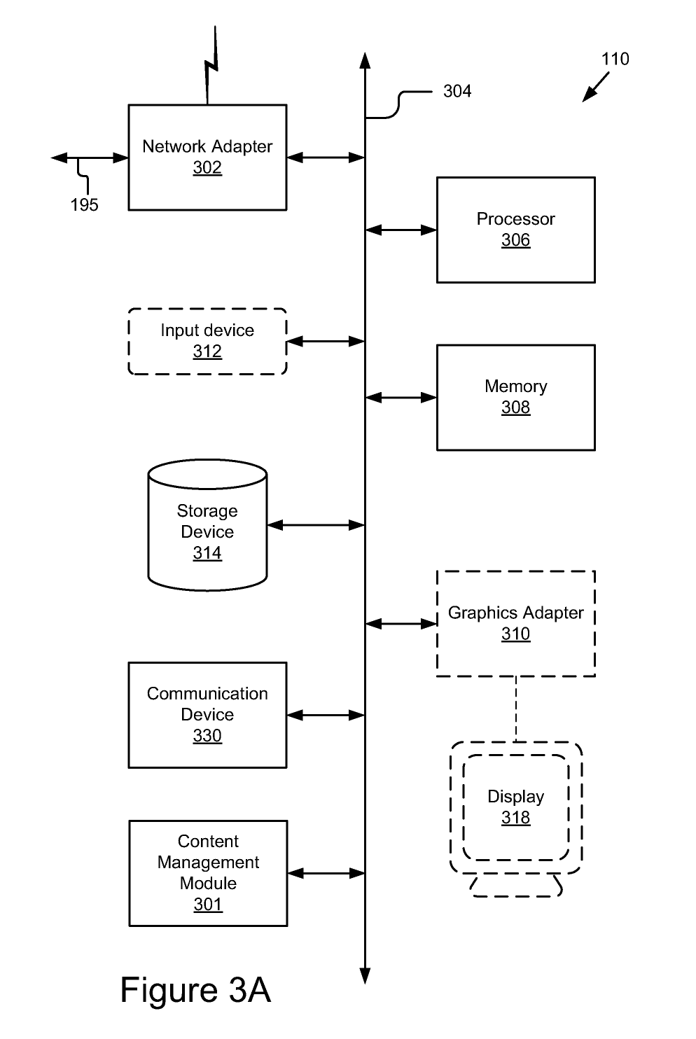

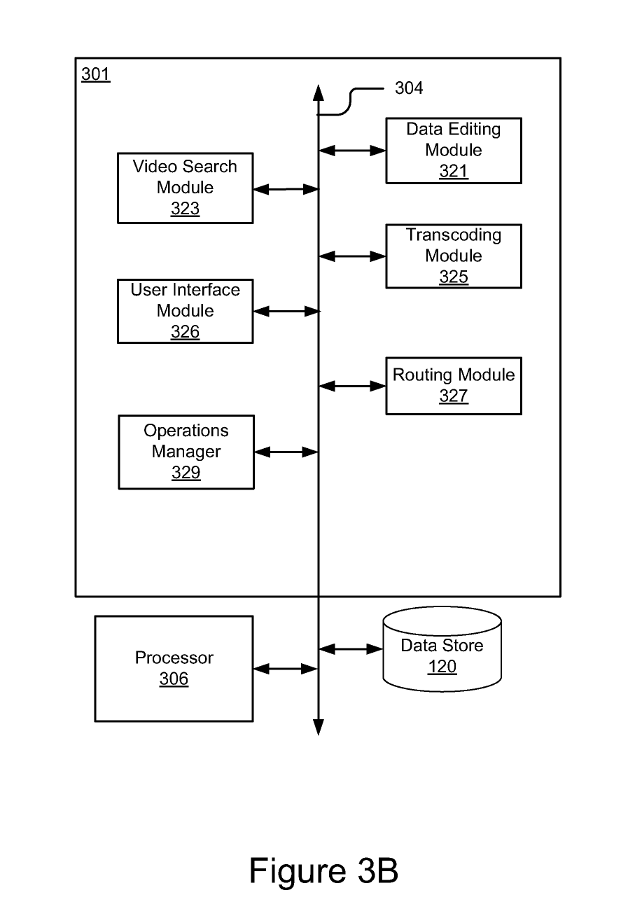

Additionally, the CMS 110 includes data or instructions for generating one or more user interfaces displaying video data and metadata retrieved from the data store 120. The user interfaces generated by the CMS 110 simplify user review and modification of metadata associated with the video data, allowing publishers to customize presentation of the video data to other users via a destination site 170 and presentation of content along with the video data. For example, a user interface generated by the CMS 110 allows a publisher to customize the branding or skin of an embedded media player 115 used to present the video data when retrieved from a destination site 170 by modifying the metadata used by the CMS 110 to generate customized configuration data for the media player 115. As another example, a user interface generated by the CMS 110 allows a publisher to customize the temporal location and placement of supplemental content, such as an advertisement (“ad”), within video data when the video data is presented by a media player 115 operating on a user device 160. The CMS 110 is further described below in conjunction with FIGS. 3A and 3B.

The data store 120 is a non-volatile memory device or similar persistent storage device and media coupled to the CMS 110 for storing video data and metadata associated with stored video data. For example, the data store 120 and the CMS 110 exchange data with each other via the network 150. Alternatively, the data store 120 and the CMS 110 exchange data via a dedicated communication channel. While the embodiment shown by FIG. 1 depicts the data store 120 and CMS 110 as discrete components, in other embodiments a single component includes the data store 120 and the CMS 110.

In one embodiment, the data store 120 includes one or more tables associating metadata with video data. For example, the data store 120 includes a table where an entry in the table includes a field identifying the video data and additional fields include metadata associated with the video data. Additionally, the data store 120 may include additional tables identifying data used by a destination site 170 when storing video data for access by user devices 160. In one embodiment, the data store 120 includes data mapping metadata associated with video data to data used by a destination site 170. The mapping of metadata associated with video data to data used by a destination site 170 allows the data store 120 to automatically map metadata associated with video data with one or more data fields used by a destination site 170, which beneficially reduces the time for a destination site 170 to store and communicate video data from the data store 120 to a user device 160. In one embodiment, the data store 120 or the CMS 110 includes an index to expedite identification and/or retrieval of stored data from the data store 120.

The analytics server 123 is one or more devices having at least one processor coupled to at least one storage device including instructions for execution by the processor. For example, the analytics server 123 is one or more servers or other computing devices having data processing and data communication capabilities. The analytics server 123 tracks user page level interactions by receiving event data describing video level events from the user devices 160. The analytics server 123 receives the event data from a media player 115 associated with a user device 160. The analytics server 123 calculates and tracks metrics that are defined by one or more of an administrator of the analytics server 123, an administrator of the CMS 110, an administrator of the third party video server 180 or a human user of the user device 160. In one embodiment, the media player 115 includes a module that determines metrics that need to be tracked and communicates these metrics to the analytics server 123. In this embodiment, the media player 115 defines one or more of the metrics tracked by the analytics server 123.

A video level event is any user interactions with one or more of a media player 115 and a web page that contains one or more videos. Examples of video level events based on user interaction with a media player 115 include the following: the user provides an input to the media player 115 to cause a video to begin playback (e.g., pressing the play button of the media player 115); the user provides an input to the media player 115 to change the volume setting for a video; the user mouses over a portion of the video displayed by the media player 115; the user provides an input to the media player 115 to maximize the size of the media player 115 screen; the user changes the location of the media player 115 on the display of the user device 160; the user provides an input to the media player 115 to pause playback of the video; the user provides an input to the media player 115 to stop playback of the video (e.g., pressing stop, clicking through to a new web page, etc.); the user provides an input to the media player 115 to have a social interaction with the video (e.g., “liking” the video, “favoriting” the video, “sharing” the video, commenting on the video, etc.); the user provides an input to the media player 115 to pop-out the screen of the media player 115; the user provides an input to the media player 115 to navigate a playlist included in the media player 115 (paging); the user provides an input to the media player 115 to subscribe to the video or the video stream of another user (a “subscription input”).

The web page that includes the video is displayed in a browser operating on the user device 160. Examples of video level events based on user interaction with a web page that contains one or more videos include the following: the user provides an input to the browser to open a new page or tab in the browser; the user provides an input to the web page to cause a video to begin playback; the user provides an input to the web page or an operating system of the user device 160 to change the volume setting for a video; the user mouses over a portion of the web page; the user provides an input to the browser to maximize the size of a window in which video playback is occurring; the user changes the location of the media player 115 in the web page; the user provides an input to the web page to pause playback of the video; the user provides an input to stop playback of the video (e.g., pressing stop, clicking through to a new web page, etc.); the user provides an input to the web page to have a social interaction with the video (e.g., “liking” the video, “favoriting” the video, “sharing” the video, commenting on the video, etc.); the user provides an input to the web page to cause the screen of the media player 115 to pop-out; the user provides an input to the web page to navigate a playlist included in the media player 115 (paging); the user provides an input to the web page to subscribe to the video or the video stream of another user.

In one embodiment, the browser of the user device 160 is configured to receive and respond to voice commands from a user of the user device 160. For example, the browser is Google Chrome™ and can receive and respond to voice commands from the user of the user device 160. The user is viewing a video on a web page in the browser. The user speaks a command to cause the browser to navigate to a new web page, thereby causing the media player 115 to log a video level event associated with the user navigating away from the web page including the video.

The media player 115 and the web page containing one or more videos are referred to collectively as a “web-based video player.”

The analytics server 123 tracks video level events that occur before, during and after a video view. In one embodiment, the media player 115 tracks these video level events. A video view is an event in which a user of a user device 160 interacts with a media player 115 to view all or a portion of a video in the web page. Such an event is an example of a video level event that is described by event data. In one embodiment, the analytics server 123 receives event data describing the user interactions with additional elements (i.e., elements other than the video) of a web page. For example, the event data indicates that a browser (not pictured) stored and executed by the user device 160 has submitted a comment for a video. In another embodiment, the event data describes whether the media player 115 remains in view on the browser.

In one embodiment, the analytics server 123 analyzes the event data describing video level events and generates analytics data from the event data. The event data describes how users interact with web pages that include one or more videos provided by one of a destination site 170, a third party video server 180 and the CMS 110. The analytics data is web analytics data describing the event data.

In one embodiment, the analytics server 123 tracks analytics data for the following metrics: number of times one or more videos is played; the percentage of playback that is completed for a video; the number of users that bounce (i.e., users that do not interact further in any measurable way) from a page that includes a video; etc. As described below, in one embodiment the analytics server 123 tracks for different metrics.

In one embodiment, the event data is sessionized. For example, the event describes, for one or more sessions, user interactions with web pages that include one or more videos provided by one of a destination site 170, a third party video server 180 and the CMS 110. A session is a pre-determined period of time (e.g., an hour, a day, a week, a month, etc.) defined by an administrator of the analytics server 123 or the CMS 110.

The analytics server 123 receives one or more requests from a media player 115 operable in the user device 160. As described above, in one embodiment the media player 115 is code and routines stored and executed by the user device 160. In another embodiment, the media player 115 is generated and transmitted to the user device 160 by the CMS 110. In either embodiment, the media player 115 generates and transmits a request to the analytics server 123. A request includes data describing a status or a change of status of the media player 115. For example, a request includes data describing that the media player 115 has played a video through 25% of its total length. In another example, a request indicates that the media player 115 was paused while it was playing an advertisement. Before, during and after the media player 115 is loaded by the user device 160, requests are communicated from the media player 115 to the analytics server 123.

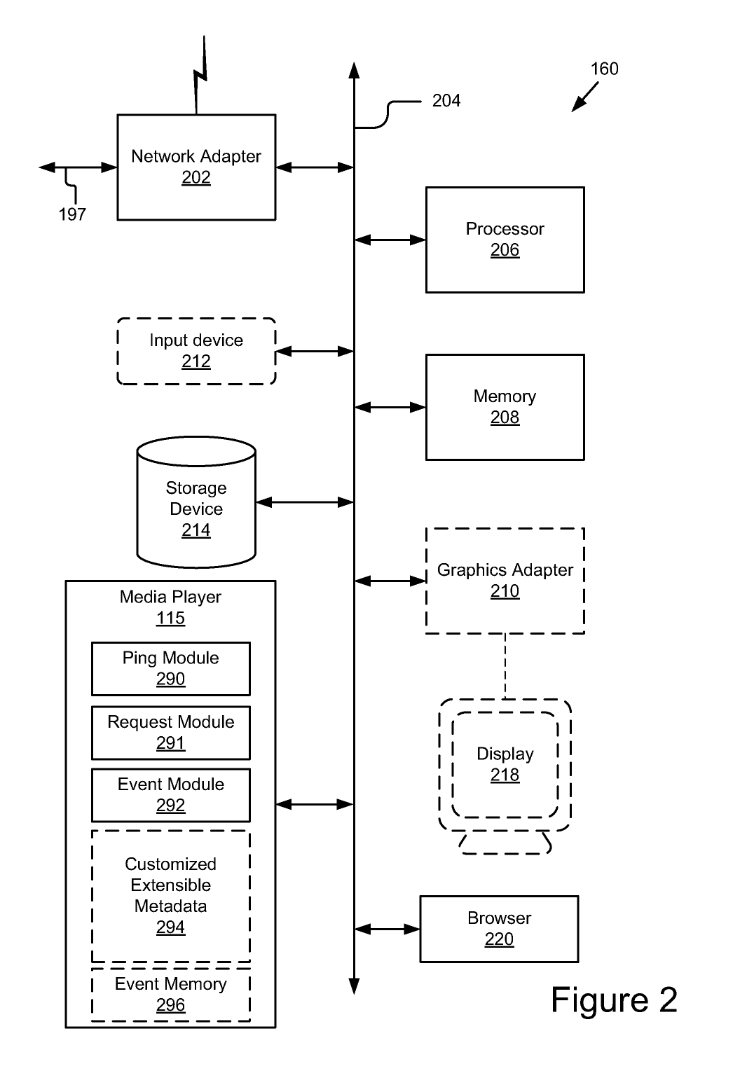

In one embodiment, a request includes data describing one or more video level events. The event data describing video level events and the media player 115 are further described in more detail below with reference to FIG. 2.

The analytics server 123 generates reports using the analytics data. The reports describe metrics that quantify the performance of video content. For example, a sharing report displays to publishers how their content (i.e., videos) is spread by users (e.g., shares to social networks such as Buzz, shares through emails, shares via embed copies, etc.). A discovery report shows how the videos are being found by viewers, specifically, what referrers drive traffic to the videos.

The analytics server 123 generates other reports based at least in part on the analytics data. For example, the analytics server 123 generates a report describing one or more of the following: how many times video data is shared when it is played back; video data access within a specific destination site 170; the number of video data views in a specific destination site 170; the destination site 170 that referred to a video and the geographies for that destination site 170, etc. A person having ordinary skill in the art will recognize that other reports are possible.

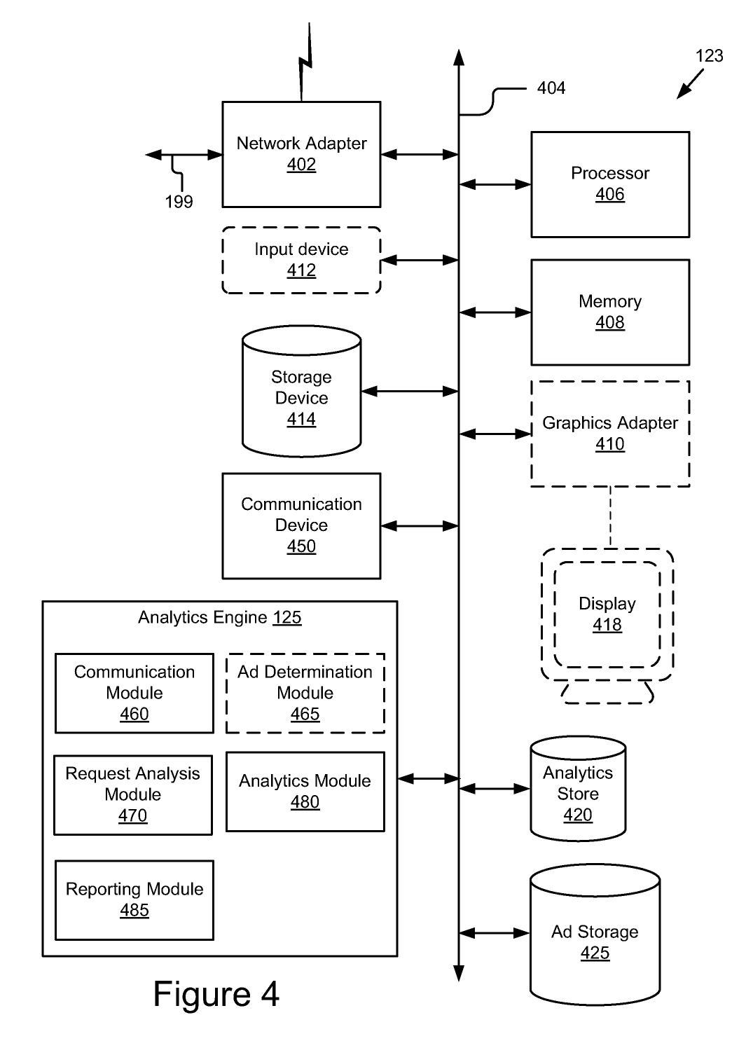

In one embodiment, the content of reports generated by the analytics server 123 is predefined by an administrator of the analytics server 123. In another embodiment, the analytics server 123 specifies one or more metrics to be included in the report (i.e., a customized report). The analytics server 123 and the analytics engine 125 are further described below in with reference to FIG. 4.

The cache 130 is coupled to the content management system (CMS) 110 using the network 150 or using a direct communication channel between the CMS 110 and the cache 130. When a user device 160 or a destination site 170 retrieves video data from the data store 120, the CMS 110 communicates the video data to the cache 130, which stores a copy of the retrieved video data. Similarly, a request for video data from a user device 160 or a destination site 170 is initially transmitted via the network 150 to the cache 130 and the requested video data is communicated to the user device 160 or the destination site 170 by the cache 130 if a copy of the video data is stored by the cache 130. If the cache 130 does not include a copy of the requested video data, the request is communicated from the cache 130 to the CMS 110 to retrieve the video data. Hence, the cache 130 expedites retrieval of video data. While FIG. 1 illustrates a single cache 130, in other embodiments, the system 100 may include multiple caches 130.

The one or more advertisement servers (“ad servers”) 140A-140N are one or more computing devices having a processor and a computer-readable storage medium storing advertisements and data for selecting advertisements. An ad server 140 communicates with the CMS 110 via the network 150 or via a communication channel with the CMS 110. Also, an ad server 140 communicates with destination sites 170, the analytics server 123, third party video servers 190 or user devices 160 via the network 150 to communicate advertisements for presentation when a web page is accessed. An ad server 140 also includes rules for targeting advertisements to specific users, for targeting advertisements to be displayed in conjunction with types of content, for targeting advertisements to specific locations or Internet Protocol (IP) addresses or other rules for selecting and/or targeting advertisements.

An ad server 140 receives metadata associated with video data from the CMS 110 and selects advertisements for presentation in conjunction with the video data based on the metadata. For example, the ad server 140 selects stored advertisements based on keywords associated with the video data. Thus, modification of the metadata associated with the video data using the CMS 110 enables modification of the advertisements presented in conjunction with the video data.

The network 150 is a conventional network and may have any number of configurations such as a star configuration, a token ring configuration or another configuration known to those skilled in the art. In various embodiments, the network 150 is a wireless network, a wired network or a combination of a wireless and a wired network. Furthermore, the network 150 may be a local area network (LAN), a wide area network (WAN) (e.g., the Internet) and/or any other interconnected data path across which multiple devices may communicate. In yet another embodiment, the network 150 may be a peer-to-peer network.

The network 150 may also be coupled to, or include, portions of a telecommunications network for communicating data using a variety of different communication protocols. In yet another embodiment, the network 150 includes a Bluetooth communication network and/or a cellular communications network for sending and receiving data. For example, the network 150 transmits and/or receives data using one or more communication protocols such as short messaging service (SMS), multimedia messaging service (MMS), hypertext transfer protocol (HTTP), direct data connection, WAP, email or another suitable communication protocol.

The one or more user devices 160A, 160B, 160C are computing devices having data processing and data communication capabilities. For example, a user device 160 comprises a desktop computer, a laptop computer, a netbook computer, a tablet computer, a smartphone or any connected devices such as a Internet Protocol-connected television or a smart television. In one embodiment, different user devices 160A, 160B, 160C comprise different types of computing devices. For example, the user device 160A is a smartphone, the user device 160B is a tablet computer and the user device 160C is a laptop computer.

A user device 160 receives data from a user identifying a video (e.g., a title of the video, a video identification) and transmits the received data to a destination site 170 or to the CMS 110 via the network 150. The user device 160 then receives video data for the video through the network 150, allowing presentation of the video by the user device 160 to the user. For example, the video is presented on the media player 115. Similarly, the user device 160 receives metadata associated with video data from a user and transmits the metadata to the CMS 110 via the network 150 or receives metadata associated with video data from the CMS 110 from the network 150, allowing a user to view and/or modify the metadata using the user device 160.

In one embodiment, the user device 160 receives inputs from a user interacting with a webpage, the browser, the media player 115, etc. The media player 115 detects a video level event indicating user interactions with the webpage, the browser, the media player 115 before, during and after watching a video. In one embodiment, the user device 160 stores the event data describing the video level events in a buffer.

A user device 160 transmits data to the CMS 110 via the network 150 and receives data from the CMS 110 and/or the cache 130 via the network 150. For example, a user device 160 communicates video data to the CMS 110 via the network 150 or receives metadata associated with video data and/or user interface data from the CMS 110. Additionally, a user device 160 receives data from a destination site 170 via the network 150.

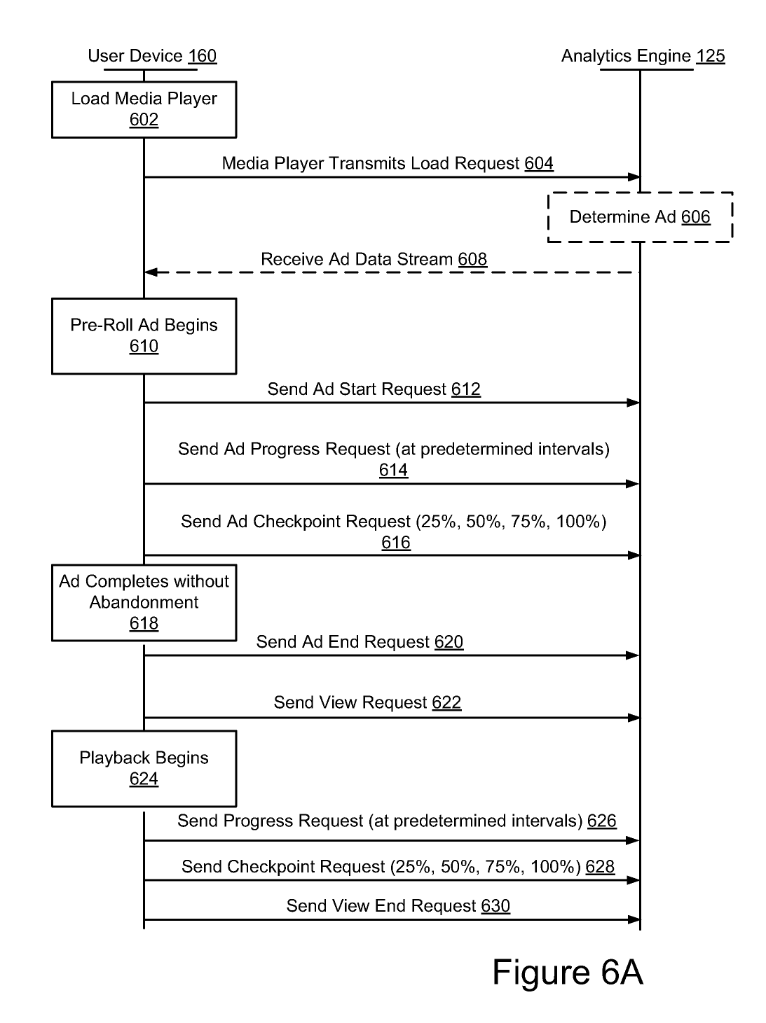

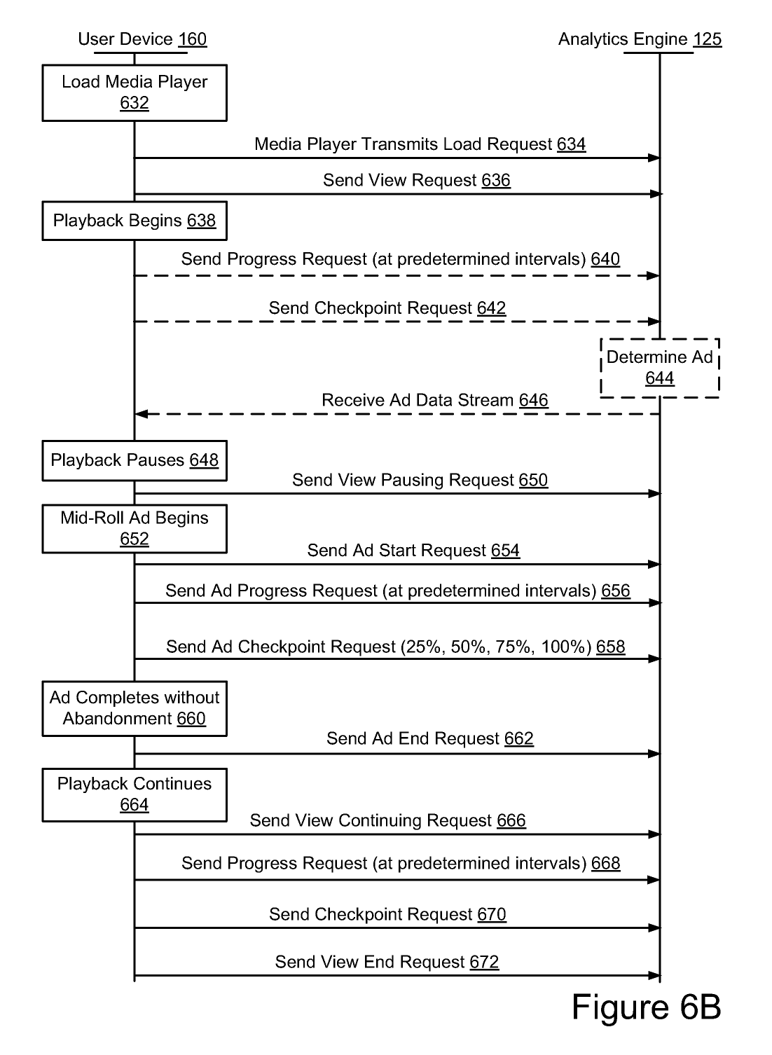

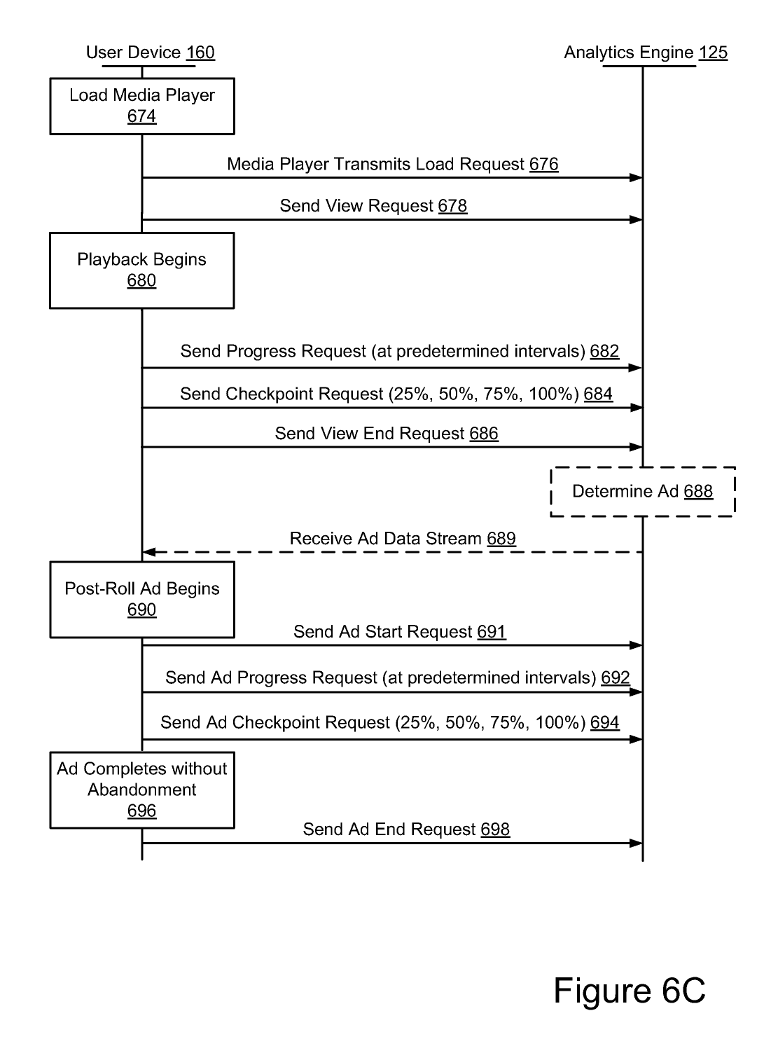

The user device 160 also transmits data, via the network 150, to the analytics server 123. For example, the user device 160 transmits event data describing video level events to the analytics server 123 via the network 150. In one embodiment, the user device 160 generates a request including data describing the status of the media player 115. In other embodiments the request includes data describing a change in the status of the media player 115. Such requests are generated and transmitted to the analytics server 123 by the media player 115. Different types of requests and communications between the user device 160 and the analytics server 123 are described in further detail below with reference to FIGS. 6A-6C.

The destination sites 170A-170N are computing devices having data processing and data communication capabilities, such as web servers. A destination site 170 includes data describing one or more web pages and communicates one or more web pages to a user device 160 via the network 150. One or more web pages stored by a destination site 170 include data or instructions for presenting video data by executing a media player 115 on the user device 160. In one embodiment, a destination site 170 retrieves video data and the media player 115 used to present the video data from the CMS 110, allowing the destination site 170 to present video data using the architecture of the CMS 110. Alternatively, a destination site 170 receives video data and configuration data for a media player 115 from the CMS 110 and embeds the video data and the configuration data into web pages to present video data. For example, a destination site 170 receives embed code describing operation of the media player 115 and identifying video data presented by the media player 115 and includes the embed code in a web page.

Thus, a user device 160 receives a web page from a destination site 170 to access content from the destination site 170 and communicates with the destination site 170 to navigate through a web page maintained by the destination site 170. One or more web pages stored by the destination site 170 include video data that is presented to the user by a media player 115.

The third party video server 180 is one or more devices having at least one processor coupled to at least one storage device including instructions for execution by the processor. For example, the third party video server 180 is a conventional server, a server array or any other computing device or group of computing devices, having data processing and communication capabilities. In one embodiment, the third party video server 180 receives video data and metadata from one or more publishers operating on one or more user devices 160 and provides videos described by the video data and metadata to one or more users. For example, the third party video server 180 publishes a video provided by an owner of the video on a web site and presents the video to a user operating on a user device 160 when a request to view the video is received from the user. The third party video server 180 is communicatively coupled to other components of the system 100 via the network 150.

The third party ad server 190 is any computing device having a processor and a computer-readable storage medium storing advertisements and data for selecting advertisements. For example, the third party server 190 selects an advertisement for a video and sends the advertisement to a user device 160 when the video is played by a media player 115 on the user device 160. The third party ad server 190 is communicatively coupled to other components of the system 100 via the network 150. In one embodiment, the third party ad server 190 provides functionalities similar to those provided by the ad server 140.

### User Device 160

FIG. 2 is a block diagram of one embodiment of a user device 160. As illustrated in FIG. 2, the user device 160 includes a network adapter 202 coupled to a bus 204. According to one embodiment, also coupled to the bus 204 are at least one processor 206, a memory 208, a graphics adapter 210, an input device 212, a storage device 214 and a media player 115. In one embodiment, the functionality of the bus 204 is provided by an interconnecting chipset. The user device 160 also includes a display 218, which is coupled to the graphics adapter 210. The input device 212, the graphics adapter 210 and the display 218 are depicted using dashed lines to indicate that they are optional features of the user device 160.

The network adapter 202 is an interface that couples the user device 160 to a local or wide area network. For example, the network adapter 202 is a network controller that couples to the network 150 via signal line 197 for data communication between the user device 160 and other components of the system 100. In one embodiment, the network adapter 202 is communicatively coupled to a wireless network (e.g., a wireless local area network) via a wireless channel 230.

The processor 206 may be any general-purpose processor. The processor 206 comprises an arithmetic logic unit, a microprocessor, a general purpose controller or some other processor array to perform computations, provide electronic display signals to display 218. The processor 206 is coupled to the bus 204 for communication with the other components of the user device 160. Processor 206 processes data signals and may comprise various computing architectures including a complex instruction set computer (CISC) architecture, a reduced instruction set computer (RISC) architecture, or an architecture implementing a combination of instruction sets. Although only a single processor is shown in FIG. 2, multiple processors may be included. The user device 160 also includes an operating system executable by the processor such as, but not limited to, WINDOWS®, MacOS X, Android, or UNIX® based operating systems.

The memory 208 holds instructions and data used by the processor 206. The instructions and/or data comprise code for performing any and/or all of the techniques described herein. The memory 208 may be a dynamic random access memory (DRAM) device, a static random access memory (SRAM) device, flash memory or some other memory device known in the art. In one embodiment, the memory 208 also includes a non-volatile memory such as a hard disk drive or flash drive for storing log information on a more permanent basis. The memory 208 is coupled by the bus 204 for communication with the other components of the user device 160. In one embodiment, the media player 115 is stored in the memory 208 and executable by the processor 206.

The storage device 214 is any device capable of holding data, like a hard drive, compact disk read-only memory (CD-ROM), DVD, or a solid-state memory device. The storage device 214 is a non-volatile memory device or similar permanent storage device and media. The storage device 214 stores data and instructions for the processor 206 and comprises one or more devices including a hard disk drive, a floppy disk drive, a CD-ROM device, a DVD-ROM device, a DVD-RAM device, a DVD-RW device, a flash memory device, or some other mass storage device known in the art. For clarity, instructions and/or data stored by the storage device 214 are described herein as different functional “modules,” where different modules are different instructions and/or data included in the storage device that cause the described functionality when executed by the processor 206.

The input device 212 may include a mouse, track ball, or other type of pointing device to input data into the user device 160. The input device 212 may also include a keyboard, such as a QWERTY keyboard. The input device 212 may also include a microphone, a web camera or similar audio or video capture device.

The graphics adapter 210 displays images and other information on the display 218. The display 218 is a conventional type such as a liquid crystal display (LCD) or any other similarly equipped display device, screen, or monitor. The display 218 represents any device equipped to display electronic images and data as described herein.

The media player 115 is code and routines for presenting video data to a user. For example, the media player 115 is a video player executed by a browser 220 to stream video data from one of the CMS 110, the destination site 170 and the third party video server 180 and presents the video data to a user. In one embodiment, the media player 115 is included on one or more web pages provided by one of a destination site 170, a third party video server 180 and the CMS 110. For example, the user device 160 receives a web page from the destination site 170 and generates a media player 115 to present video data to the user according to an embed code in the web page. In another embodiment, the media player 115 is code and routines stored in a memory of the user device 160 (e.g., one of memory 208 and storage device 214) and executed by the processor 206 to provide the functionality described herein.

Further, the media player 115 is code and routines for transmitting requests and capturing video level events. For example, videos played by the media player 115 include advertisements (“ads”). The media player 115 transmits an ad start request to the analytics server 123 when the ad starts to play. The ad start request signals to the analytics server 123 that the ad has started playing on the media player 115. In one embodiment, the media player 115 detects video level events and transmits event data describing the video level events to the analytics server 123. In one embodiment, the event data is included in requests that are sent by the media player 115 to the analytics server 123. For example, the event data is a hashed component of a request. Assume, for example, that a user clicks a like button while watching a video. The like button is a component of the graphical representation of the media player displayed on the display 218. The media player 115 receives the like button input. This input is a video level event because it was generated as a result of a user's interaction with the media player 115 or a webpage. Other types of video level events are possible. The media player 115 generates event data describing the like button click. The media player 115 then hashes the event data to a request and transmits the request and the hashed event data to the analytics server 123.

In the depicted embodiment, the media player 115 includes, among other things, a ping module 290, a request module 291, an event module 292, a set of customized extensible metadata 294 and an event memory 296. These components of the custom media player 115 are communicatively coupled to one another. The customized extensible metadata 294 and the event memory 296 are depicted with dashed lines to indicate that they are optional features of the media player 115.

The ping module 290 is code and routines for handling communication between the media player 115 and other components of the system 100. For example, the ping module 290 transmits a request generated by the request module 291 to the analytics server 123. In one embodiment, the ping module 290 receives video data from one of the CMS 110, the third party video server 180 and the destination site 170. In another embodiment, the ping module 290 receives data for an advertisement from one of the ad server 140, the third party ad server 190 and the analytics server 123.

The request module 291 is code and routines for generating a request. A request includes one or more of a unique video identifier (“video ID”) to identify a video, a video version identifier to indicate a version of the video (a video can have different versions; the video version identifier indicates which of these versions a video level event is related to, e.g., a second version of a video), a location identifier (e.g., a user device's 160 internet protocol address) and an embedded Uniform Resource Locator (“URL”) for a web page including the video. For example, a request includes a video ID and a video version identifier. There are different kinds of requests that indicate different information to the analytics server 123. Examples of different kinds of requests are described below with reference to FIGS. 6A-6C.

In one embodiment, requests are generated based at least in part on a viewer's progress in watching a video. For example, the request module 291 generates a checkpoint request when a video has been viewed through 25%, 50%, 75% and 100% of the total length of the video. After 25% of the video has been viewed, a first checkpoint request is generated by the request module 291 and sent by the ping module 290 to the analytics server 123. A second, third and fourth checkpoint request are generated and sent after 50%, 75% and 100% of the video are viewed provided playback lasts that long. Checkpoint requests are described in further detail below with reference to FIGS. 6A-6C. Similar to a checkpoint request, an administrator of the analytics server 123 can configure the media player to send a progress request to the analytics server 123 at intervals defined by the administrator (e.g., every 1 second). Progress requests are described in more detail below with reference to FIGS. 6A-6C.

In one embodiment, a request also includes event data. Event data is data describing one or more events occurring at the user device 160. For example, the event data describes one or more of the following: the user plays a video; the user changes the volume setting for a video; the user mouses over a portion of the video or the web page; the user maximizes the size of the media player screen; the location of the media player on the display of the user device; the user opens a new page or tab in the browser 220 of the user device 160; the user pauses playback of the video; the user takes any action to stop playback of the video (e.g., pressing stop, clicking through to a new web page, etc.); the user has a social interaction with the video (e.g., “liking” the video, “favoriting” the video, “sharing” the video, etc.); the user pops-out the screen of the media player; the user takes steps for playlist navigation (skipping to the next video); the user subscribes to the video or the video stream of another user; the user comments on the video.

In one embodiment, the event data is associated with a video ID and a video version identifier included in the request. The association indicates that the video level event that is described by the event data occurred with reference to the video described by the video ID and the video version identifier. The analytics engine 125 analyzes the event data and the associated video ID and video version identifier to determine that the video level event described by the event data occurred with reference to the video described by the video ID and the video version identifier. For example, the analytics engine 125 determines that the video level events indicate that the user is interested in a particular version of a video described by a combination of a video ID and a video version identifier.

Other examples of requests generated by the request module 291 include, but are not limited to the following: a load request indicating that the media player 115 is loaded on a web page; an ad start request indicating that an ad starts to play; an ad progress request reporting view progress of an ad at a predetermined interval (similar to the progress request described above, but relating to viewership of the advertisement instead of the video); an ad checkpoint request reporting view progress of an ad at a checkpoint (e.g., 25%, 50%, 75% and 100% of an ad's total length; similar to the checkpoint request described above, but relating to viewership of the advertisement instead of the video); an ad end request indicating that an ad has finished playing; a view request indicating that a video starts to play; a view progress request reporting view progress of a video at a predetermined interval; a view checkpoint request reporting view progress of a video at a checkpoint and a view end request reporting completion of playing a video, etc. These requests are described in more detail below with reference to FIGS. 6A-6C. Persons of ordinary skill in the art will recognize that the request module 291 may generate other requests not described above.

The event module 292 is code and routines for detecting video level events and generating event data describing the video level events. For example, when the user adds a video into a list of favorites after watching the video, the event module 292 detects this activity as a video level event and generates event data describing this activity. In one embodiment, the event module 292 transmits the event data to the event memory 296 for storage or buffering. In another embodiment, the event module 292 sends the event data to the request module 291 for attaching (e.g., hashing) the event data to a request. In another embodiment, event data is sent to the ping module 290 for transmission to the analytics server 123 separate from the requests.

A video level event describes a user interaction with elements of a web page (or media player 115) that includes one or more videos. In one embodiment, a video level event indicates the activities of viewers on a web page before, during (and when) and after they watch a video. Video level events are described by the event data. Examples of a video level event include, but are not limited to: a comment to a video; a subscription of a video; a like of a video; adding a video into favorites; sharing a video through emails; sharing a video through social networks (e.g., Buzz); sharing a video through embed copying; a click that keeps the viewer on the page (e.g., expanding a hidden section); a playlist navigation; a click through to a new video or a new page; a pop-out; and any event that determines the media player 115 remains in view on the browser 220. Persons of ordinary skills in the art will recognize that the video level event can also include any other behaviors that the users conduct before, during and after they watch a video.

The customized extensible metadata 294 is extensible metadata used to customize the media player 115. The customized extensible metadata 294 includes configuration settings for the media player 115 to implement one or more features customized by the human user of the user device 160 or an administrator of one or more of the CMS 110, analytics server 123, third party video server 180 and third party ad server 190. For example, when the media player 115 is loaded by the user device 160, the media player 115 is configured according to the customized extensible metadata 294 so that the one or more custom features are added to the media player 115.

A custom feature is any feature added to the media player 115 by changing the customized extensible metadata 294. Examples of custom features include age-gating, requiring a user login and the addition of a playback queue. Other custom features are possible.

A configuration setting is configuration information describing how a media player 115 is configured. In one embodiment, the configuration setting describes a custom feature added to the media player 115. For example, a configuration setting describes that an age-gating function is added to the media player 115 so that a user is requested to input an age when viewing a video. In one embodiment, the customized extensible metadata 294 is stored in the storage device 214 and retrieved by the media player 115 when the media player 115 is loaded.

The event memory 296 stores and buffers the event data transmitted from the event module 292. The event memory 296 may be a dynamic random access memory (DRAM) device, a static random access memory (SRAM) device, flash memory or some other memory device known in the art. In one embodiment, the memory 208 also stores requests generated by the request module 291 in conjunction with the event data.

### CMS 110

FIG. 3A is a block diagram illustrating one embodiment of a CMS 110. As illustrated in FIG. 3A, the CMS 110 includes a network adapter 302 coupled to a bus 304. According to one embodiment, also coupled to the bus 304 are at least one processor 306, a memory 308, a graphics adapter 310, an input device 312, a storage device 314, and a communication device 330. In one embodiment, the functionality of the bus 304 is provided by an interconnecting chipset. The CMS 110 also includes a display 318, which is coupled to the graphics adapter 310. The input device 312, the graphics adapter 310 and the display 318 are depicted using dashed lines to indicate that they are optional features of the CMS 110.

The network adapter 302 is an interface that couples the CMS 110 to a local or wide area network. For example, the network adapter 302 is a network controller that couples to the network 150 via signal line 195 for data communication between the CMS 110 and other components of the system 100. In one embodiment, the network adapter 302 is communicatively coupled to a wireless network (e.g., a wireless local area network) via a wireless channel 331.

The processor 306 is any general-purpose processor. The processor 306 comprises an arithmetic logic unit, a microprocessor, a general purpose controller or some other processor array to perform computations, provide electronic display signals to the display 318. The processor 306 is coupled to the bus 304 for communication with the other components of the CMS 110. The processor 306 processes data signals and may comprise various computing architectures including a complex instruction set computer (CISC) architecture, a reduced instruction set computer (RISC) architecture, or an architecture implementing a combination of instruction sets. Although only a single processor is shown in FIG. 3A, multiple processors may be included. The CMS 110 also includes an operating system executable by the processor 306 such as but not limited to WINDOWS®, MacOS X, Android, or UNIX® based operating systems.

The memory 308 holds instructions and data used by the processor 306. The instructions and/or data comprise code for performing any and/or all of the techniques described herein. The memory 308 may be a dynamic random access memory (DRAM) device, a static random access memory (SRAM) device, flash memory or some other memory device known in the art. In one embodiment, the memory 308 also includes a non-volatile memory such as a hard disk drive or flash drive for storing log information on a more permanent basis. The memory 308 is coupled by the bus 304 for communication with the other components of the CMS 110. In one embodiment, the content management module 301 is stored in memory 308 and executable by the processor 306.

The storage device 314 is any tangible device capable of storing data. The storage device 314 is a non-volatile memory device or similar permanent storage device and media. The storage device 314 stores data and instructions for the processor 306 and comprises one or more devices including a hard disk drive, a floppy disk drive, a CD-ROM device, a DVD-ROM device, a DVD-RAM device, a DVD-RW device, a flash memory device, or some other mass storage device known in the art. In some embodiments, the storage device 314 includes instructions and/or data for maintaining metadata associated with video data, for modifying stored metadata or for retrieving stored video data or stored metadata associated with stored video data. For clarity, instructions and/or data stored by the storage device 314 are described herein as different functional “modules,” where different modules are different instructions and/or data included in the storage device that cause the described functionality when executed by the processor 306.

The input device 312 may include a mouse, track ball, or other type of pointing device to input data into the CMS 110. The input device 312 may also include a keyboard, such as a QWERTY keyboard. The input device 312 may also include a microphone, a web camera or similar audio or video capture device. The graphics adapter 310 displays images and other information on the display 318. The display 318 is a conventional type such as a liquid crystal display (LCD) or any other similarly equipped display device, screen, or monitor. The display 318 represents any device equipped to display electronic images and data as described herein.

The communication device 330 transmits data from the CMS 110 to the network 150 and receives data from the network 150. The communication device 330 is coupled to the bus 304. In one embodiment, the communication device 330 also exchanges data with one or more of the analytics server 123, the data store 120, the cache 130, the third party video server 180, the third party ad server 190 and/or one or more ad servers 140 using communication channels other than the network 150. In one embodiment, the communication device 330 includes a port for direct physical connection to the network 150 or to another communication channel. For example, the communication device 330 includes a USB, SD, CAT-5 or similar port for wired communication with the network 150. In another embodiment, the communication device 330 includes a wireless transceiver for exchanging data with the network 150, or with another communication channel, using one or more wireless communication methods, such as IEEE 802.11, IEEE 802.16, BLUETOOTH® or another suitable wireless communication method.

In yet another embodiment, the communication device 330 includes a cellular communications transceiver for sending and receiving data over a cellular communications network such as via short messaging service (SMS), multimedia messaging service (MMS), hypertext transfer protocol (HTTP), direct data connection, WAP, e-mail or another suitable type of electronic communication. In still another embodiment, the communication device 330 includes a wired port and a wireless transceiver. The communication device 330 also provides other conventional connections to the network 150 for distribution of files and/or media objects using standard network protocols such as TCP/IP, HTTP, HTTPS and SMTP as will be understood to those skilled in the art.

FIG. 3A further illustrates a content management module 301 communicating over bus 304 with the other components of the CMS 110. The content management module 301 provides logic and instructions for storing video data from a publisher and providing the video data to other users. In one embodiment, the content management module 301 can be implemented in hardware (e.g., in an FPGA), as illustrated in FIG. 3A. In another embodiment, the content management module 301 can include software routines and instructions that are stored, for example, in the memory 308 and/or storage device 314 and executable by the processor 306 to cause the processer to store video data from a publisher and provide the video data to other users. Details describing the functionality and components of the content management module 301 will be explained in further detail below with reference to FIG. 3B.

As is known in the art, the CMS 110 can have different and/or other components than those shown in FIG. 3A. In addition, the CMS 110 can lack certain illustrated components. In one embodiment, the CMS 110 lacks an input device 312, graphics adapter 310, and/or display 318. Moreover, the storage device 314 can be local and/or remote from the CMS 110 (such as embodied within a storage area network (SAN)).

As is known in the art, the CMS 110 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 314, loaded into the memory 308, and executed by the processor 306.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

### Content Management Module 301

Turning now to the content management module 301, FIG. 3B is a block diagram illustrating one embodiment of the content management module 301. In the embodiment depicted by FIG. 3B, the content management module 301 includes a data editing module 321, a video search module 322, a transcoding module 325, a user interface module 326, a routing module 327 and an operations manager 329. In other embodiments, the content management module 301 includes different and/or additional modules than the ones depicted in FIG. 3B.

In one embodiment, the modules are implemented using instructions and/or data included in the storage device 314. In another embodiment, the modules are implemented using one or more hardware devices configured to provide the functionality further described below. For example, the modules are implemented using one or more application specific integrated circuits (ASICs) and/or one or more FPGAs coupled to the bus 304 and configured to provide the functionality of the modules further described below.

The data editing module 321 is software and routines executable by the processor 306 for modifying metadata and/or video data stored in the data store 120. In one embodiment, the data editing module 321 receives data from a user of the user device 160 via the user interface module 326. The data editing module 321 uses the received data to generate (or modify) metadata that is stored by the data store 120. Additionally, the data editing module 321 generates or modifies playlists including a sequence of video data based on data received from a user device 160 via the user interface module 326. For example, the user interface module 326 receives data for modifying stored metadata associated with video data (or data identifying metadata for association with video data) from a user device 160 via the network 150 and the bus 304. The data editing module 321 modifies the metadata associated with the video data using the received data. In one embodiment, the data editing module 321 stores the received metadata and an association between the received metadata and video data in the data store 120 as described in further detail below.

In one embodiment, the data editing module 321 generates an instruction identifying the metadata to be modified and describing the modification to the metadata. In another embodiment, the data editing module 321 generates an instruction identifying metadata and video data associated with the metadata. The generated instruction is then transmitted to the data store 120 by the communication device 330 to modify the metadata. Similarly, the data editing module 321 generates an instruction modifying a playlist, identifying modifications to the video data included in the playlist or identifying one or more attributes associated with the playlist to be modified. The generated instruction is transmitted to the data store 120 via the bus 304, the communication device 330 and the network 150.

The video search module 322 is software and routines executable by the processor 306 for generating data or instructions for retrieving video data from the data store 120 based on received input, such as search terms. The video search module 322 searches the data store 120 for metadata that match or are similar to search terms received from the communication device 330 and/or from the user interface module 326. Hence, the video search module 322 allows users to more easily retrieve stored video data using metadata associated with the stored video data. For example, the video search module 322 accesses the data store 120 via the network 150, the communication device 330 and the bus 304 to identify video data associated with metadata that match or are similar to search terms received from the communication device 330 and/or from the user interface module 326.

Rather than require navigation through a directory structure to retrieve stored video data, like conventional data retrieval, the video search module 322 searches metadata associated with stored video data to identify and retrieve stored video data. In one embodiment, the video search module 322 also receives data limiting the metadata to which the search terms are compared. For example, the video search module 322 receives input limiting comparison of search terms to metadata specifying video title and not to other metadata. The video search module 322 also receives data from the data store 120 describing stored video data associated with metadata that match or are similar to the search terms. The video search module 322 communicates the description of the stored video data to the user interface module 326 via the bus 304, and the user interface module 326 generates a user interface presenting the video data from the data store 120 to a user.

The transcoding module 325 is software and routines executable by the processor 306 for generating a copy of the video data encoded in a different format than the video data's original format. The transcoding module 325 includes one or more codecs for generating differently encoded copies of the video data. For example, the transcoding module 325 includes multiple video codecs, such as H.262/MPEG-2 Part 2 codecs, H.264/MPEG-4 Advanced Video Coding codecs, MPEG-4 Part 2 codecs, VP8 codecs or other video codecs. By storing different video codecs, the transcoding module 325 enables generation of a compressed version of stored video data by encoding the video data with one or more of the stored video codecs. The differently-encoded copy of the video data is communicated to the data store 120 for storage and association with the original video data.

In one embodiment, the transcoding module 325 automatically encodes video data received by the CMS 110 using one or more predetermined codecs to generate one or more compressed versions of the video data, which are stored in the data store 120 along with the original video data. For example, the transcoding module 325 automatically encodes video data using one or more commonly-used codecs, such as one or more H.264/MPEG-4 Advanced Video Coding codecs or one or more VP8 codecs. This simplifies distribution of the video data to destination sites 170 by automatically generating compressed versions of the video data using codecs most commonly used by destination sites 170. In one embodiment, input received by the user interface module 326 allows a user to specify one or more codecs that are automatically applied to video data. For example, a user specifies a list of codecs to produce compressed video data compatible with user-desired destination sites 170, allowing the CMS 110 to automatically generate video data compatible with the user-desired destination sites 170.

The transcoding module 325 may also receive input via the user interface module 326, allowing manual identification of a codec and encode video data using the identified codec. Additionally, a user may communicate one or more codecs to the CMS 110 via the network 150 and the transcoding module 325 stores the user-supplied codecs for subsequent use. Additionally, destination sites 170 may communicate codecs to the transcoding module 325 via the network 150, allowing the transcoding module 325 to dynamically modify the codecs used. The transcoding module 325 may also modify the one or more codecs automatically applied to video data responsive to data from destination sites 170 and/or from user devices 160, enabling dynamic modification of video encoding as different and/or additional codecs become more commonly used.

The user interface module 326 is software and routines executable by the processor 306 for generating one or more user interfaces for receiving data from a user and/or presenting video data and/or metadata associated with video data to a user. For example, the user interface module 326 includes instructions that, when executed by a processor 306, generate user interfaces for displaying metadata associated with video data and/or modifying metadata associated with video data. In one embodiment, data stored in the interface module 326 is communicated to a user device 160 via the communication device 330 and the network 150, and a processor included in the user device 160 generates a user interface by executing the instructions provided by the user interface module 326.

In one embodiment, the user interface module 326 generates a user interface to display metadata that is associated with video data and stored in the data store 120 and receives modification to the stored metadata. In another embodiment, the user interface module 326 generates a user interface identifying stored video data associated with a user from the data store 120, expediting the user's review of previously stored video data. In yet another embodiment, the user interface module 326 generates a user interface for receiving user input to upload video data from a user device 160 to the data store 120 and facilitating publication of the video data using the CMS 110.

The routing module 327 is software and routines executable by the processor 306 for identifying a destination for data received by the CMS 110 or processed by the CMS 110. After the routing module 327 determines the destination, the communication device 330 transmits the data to the determined destination using the bus 304. In one embodiment, the routing module 327 includes a routing table associating destinations with different types of data and/or with different commands. For example, the routing module 327 determines that editing commands from the data editing module 321 are routed to the data store 120 and determines that search commands from the video search module 322 are routed to the data store 120. As additional examples, the routing module 327 determines that data from the user interface module 326 is directed to a user device 160 or determines that website usage data or video access data is transmitted to the analytics server 123.

The operations manager 329 is software and routines executable by the processor 306 for generating modifications to metadata stored in the data store 120 and scheduling modification of the stored metadata. Additionally, the operations manager 329 determines when data stored by the data store 120 is changed and notifies the CMS 110 when stored data has been changed using the communication device 330 and/or the network 150 or any other connection to the data store 120. In one embodiment, the operations manager 329 maintains one or more queues for scheduling modification of stored metadata or communicating new metadata to the data store 120. The operations manager 329 also communicates changes of stored metadata to one or more destination sites 170 via the communication device 330 and the network 150, allowing a destination site 170 to receive the most current metadata. In one embodiment, the operations manager 329 generates a queue or other schedule specifying the timing of communication of metadata to one or more destination sites 170.

### Analytics Server 123

Referring now to FIG. 4, the analytics server 123 and analytics engine 125 are shown in more detail. As illustrated in FIG. 4, the analytics server 123 includes a network adapter 402 coupled to a bus 404. According to one embodiment, also coupled to the bus 404 are at least one processor 406, a memory 408, a graphics adapter 410, an input device 412, a storage device 414, an analytics engine 125, an analytics store 420, an advertisement storage (“ad storage”) 425 and a communication device 450. In one embodiment, the functionality of the bus 404 is provided by an interconnecting chipset. The analytics server 123 also includes a display 418, which is coupled to the graphics adapter 410. The input device 412, the graphics adapter 410 and the display 418 are depicted using dashed lines to indicate that they are optional features of the analytics server 123. Persons of ordinary skill in the art will recognize that the analytics server 123 can have different and/or other components than those shown in FIG. 4. In addition, the storage device 414 can be local and/or remote from the analytics server 123 (such as embodied within a storage area network (SAN)).

As is known in the art, the analytics server 123 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device, loaded into the memory, and executed by the processor 406.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

The network adapter 402 is an interface that couples the analytics server 123 to a local or wide area network. For example, the network adapter 402 is a network controller that couples to the network 150 via signal line 199 for data communication between the analytics server 123 and other components of the system 100. In one embodiment, the network adapter 402 is communicatively coupled to a wireless network (e.g., a wireless local area network) via a wireless channel 433.

The processor 406 is any general-purpose processor. The processor 406 comprises an arithmetic logic unit, a microprocessor, a general purpose controller or some other processor array to perform computations, provide electronic display signals to the display 418. The processor 406 is coupled to the bus 404 for communication with the other components of the analytics server 123. The processor 406 processes data signals and may comprise various computing architectures including a complex instruction set computer (CISC) architecture, a reduced instruction set computer (RISC) architecture, or an architecture implementing a combination of instruction sets. Although only a single processor is shown in FIG. 4, multiple processors may be included. The analytics server 123 also includes an operating system executable by the processor 406 such as but not limited to WINDOWS®, MacOS X, Android, or UNIX® based operating systems.

The memory 408 holds instructions and data used by the processor 406. The instructions and/or data comprise code for performing any and/or all of the techniques described herein. The memory 408 may be a dynamic random access memory (DRAM) device, a static random access memory (SRAM) device, flash memory or some other memory device known in the art. In one embodiment, the memory 408 also includes a non-volatile memory such as a hard disk drive or flash drive for storing log information on a more permanent basis. The memory 408 is coupled by the bus 404 for communication with the other components of the analytics server 123. In one embodiment, the analytics engine 125 is stored in the memory 408 and executable by the processor 346.

The storage device 414 is any device capable of holding data, like a hard drive, compact disk read-only memory (CD-ROM), DVD, or a solid-state memory device. The storage device 414 is a non-volatile memory device or similar permanent storage device and media. The storage device 414 stores data and instructions for the processor 408 and comprises one or more devices including a hard disk drive, a floppy disk drive, a CD-ROM device, a DVD-ROM device, a DVD-RAM device, a DVD-RW device, a flash memory device, or some other mass storage device known in the art. In some embodiments, the storage device 414 includes instructions and/or data for maintaining metadata associated with video data, for modifying stored metadata or for retrieving stored video data or stored metadata associated with stored video data. For clarity, instructions and/or data stored by the storage device 414 are described herein as different functional “modules,” where different modules are different instructions and/or data included in the storage device that cause the described functionality when executed by the processor 406.

The input device 412 may include a mouse, track ball, or other type of pointing device to input data into the analytics server 123. The input device 412 may also include a keyboard, such as a QWERTY keyboard. The input device 412 may also include a microphone, a web camera or similar audio or video capture device. The graphics adapter 410 displays images and other information on the display 418. The display 418 is a conventional type such as a liquid crystal display (LCD) or any other similarly equipped display device, screen, or monitor. The display 418 represents any device equipped to display electronic images and data as described herein.

The communication device 450 transmits data from the analytics server 123 to the network 150 and receives data from the network 150. The communication device 450 is coupled to the bus 404. In one embodiment, the communication device 450 also exchanges data with one or more of the CMS 110, the data store 120, the cache 130 and/or one or more ad servers 140 using communication channels other than the network 150. In one embodiment, the communication device 450 includes a port for direct physical connection to the network 150 or to another communication channel. For example, the communication device 450 includes a USB, SD, CAT-5 or similar port for wired communication with the network 150. In another embodiment, the communication device 450 includes a wireless transceiver for exchanging data with the network 150, or with another communication channel, using one or more wireless communication methods, such as IEEE 802.11, IEEE 802.16, BLUETOOTH® or another suitable wireless communication method.

In yet another embodiment, the communication device 450 includes a cellular communications transceiver for sending and receiving data over a cellular communications network such as via short messaging service (SMS), multimedia messaging service (MMS), hypertext transfer protocol (HTTP), direct data connection, WAP, e-mail or another suitable type of electronic communication. In still another embodiment, the communication device 450 includes a wired port and a wireless transceiver. The communication device 450 also provides other conventional connections to the network 150 for distribution of files and/or media objects using standard network protocols such as TCP/IP, HTTP, HTTPS and SMTP as will be understood to those skilled in the art.

The analytics engine 125 is code and routines that, when executed by the processor 406, analyzes event data describing one or more video level events and associates requests with the event data received from the media player 115. The analytics engine 125 is communicatively coupled to the bus 404 for communication with other components of the analytics server 123. In one embodiment, the analytics engine 125 provides logic and instructions for performing one or more functions of receiving requests, determining event data from requests, generating analytics data from event data, associating requests with event data included in the requests to generate analytics data, generating reports from the analytics data, determining an advertisement for a video and storing one or more of the requests, the event data, the metrics, the analytics data, the report data and graphics data in the analytics store 420.

In one embodiment, the analytics engine 125 is implemented in hardware (e.g., in an FPGA), as illustrated in FIG. 4. In another embodiment, the analytics engine 125 includes software routines and instructions that are stored, for example, in the memory 408 and/or storage device 414 and executable by the processor 406 to cause the processer 406 to implement functionalities described herein.

In the depicted embodiment, the analytics engine 125 includes a communication module 460, an ad determination module 465, a request analysis module 470, an analytics module 480 and a reporting module 485. These components of the analytics engine 125 are communicatively coupled to one another. The ad determination module 465 is depicted using a dashed line to indicate that it is an optional feature of the analytics engine 125.

The communication module 460 is code and routines for handling communication between the analytics engine 125 and other components of the system 100. In one embodiment, the communication module 460 receives requests that include event data from the media player 115 via the communication device 450 and the network 150. In another embodiment, the communication module 460 receives requests and event data from the media player 115 separately. In one embodiment, the communication module 460 sends a report generated by the reporting module 485 to a user. In another embodiment, the communication module 460 sends data stream for an ad to the media player 115.

The ad determination module 465 is code and routines for determining an ad to be played on the media player 115. For example, the ad determination module 465 parses metadata associated with a video (e.g., a keyword describing the video) and selects an ad from the ad storage 425 based at least in part on the parsed metadata. In one embodiment, an ad associated with a video is pre-determined by a publisher (e.g., an administrator of the third party video server 180) when publishing the video and the ad determination module 465 retrieves the pre-determined ad for the video from the ad storage 425 using the video ID.

In one embodiment, the ad determination module 465 retrieves analytics data for a video from the analytics store 420 and determines an ad for the video based at least in part on the analytics data. For example, if the analytics data shows that 60% of the referrers of the video are geographically located in Asia, the ad determination module 465 selects an ad related to a product that is popular in Asia (e.g., a book that teaches how to cook Chinese food).

In yet another embodiment, the ad determination module 465 determines when to play the ad during the viewing process of the video. For example, the ad determination module 465 determines whether to play the ad before playing the video (e.g., a pre-roll ad), in the middle of playing the video (e.g., an overlay ad) or after playing the video (e.g., a post roll ad).

The request analysis module 470 is code and routines for analyzing a request received from the media player 115. For example, the request analysis module 470 is a parser configured to parse any request received from the media player 115 and determine one or more of a video ID, a video version, a URL for a web page including a video and a status (or a change of status) of the media player 115 (“the media player status”). The media player status is data describing events occurring during the playback of a video. For example, the media player status describes one or more of a media player load event, start of a video, end of a video, whether 25% of a video has been played back, whether 50% of a video has been played back, whether 75% of a video has been played back, whether 100% of a video has been played back, the playback progress of a video at a predetermined interval (e.g., the playback status every two seconds), start of an ad, end of an ad, whether 25% of an ad has been played back, whether 50% of an ad has been played back, whether 75% of an ad has been played back, whether 100% of an ad has been played back, progress of an ad at a predetermined interval, pause of a video, continuation of a video, playback of a video at a time location, etc. Persons of ordinary skill in the art will recognize that the media player 115 may have other states than those listed above.

In one embodiment, the request analysis module 470 determines whether event data describing a video level event is included in a request. The request analysis module 470 analyzes the request to determine if there is event data in the request (i.e., whether there is a video level event), and, if event data is present the request analysis module 470 determines one or more metric categories for the video level event. The metric category describes which metrics the event data is relevant to. A video level event is relevant to a metric if the video level event is used in calculating the value for a metric. The metrics are described in further detail below with reference to the analytics module 480.

The request analysis module 470 stores the video ID, the video version, the URL and the status of the media player 115 in the analytics store 420. If the request analysis module 470 also detects event data describing the video level event in the request or receives event data separately from requests, the request analysis module 470 transmits the event data to the analytics store 420 for storage.

In one embodiment, the request analysis module 470 analyzes event data to identify and extracts text information and geography information from event data describing video level events, video ID data, video version log and URLs for video. For example, the text information includes key words from comments, sources names extracted from URLs, video titles and versions from video version log, referrers, dates and times when videos have been viewed, playback locations, etc. In one embodiment, the request analysis module 470 also analyzes comments and/or key words extracted from the comments to determine if they are indications of approval of videos. The request analysis module 470 stores the extracted text information and geography information in a memory such as the analytics store 420.

In one embodiment, a request includes event data associated with a video ID and a video version identifier and the request analysis module 470 analyzes the event data and the associated video ID and video version identifier to determine that the video level event described by the event data occurred with reference to the video described by the video ID and the video version identifier.

The analytics module 480 is code and routines for analyzing event data describing a video level event and determining values for metrics describing the event data based at least in part on the event data. In one embodiment, the analytics module 480 performs analysis of video level events periodically, e.g., once every 24 hours. In another embodiment, the analytics module 480 performs analysis of video level events responsive to receiving a request from a human user. For example, a publisher requests a daily report for describing the performance of videos published by the publisher. Such reports can cover any amount of time specified by the requesting party.

The analytics module 480 retrieves event data from the analytics store 420 and analyzes the event data. In one embodiment, the analytics module 480 also retrieves other information in the requests, such as the video ID, the video version and the URL for the web page including the video and uses this data to determine values for metrics.

Examples for metrics determined by the analytics module 480 include, for example, one or more of the following: the number of conversions; the total number of shares; the number of social shares, email shares, embed copies, shares to Buzz and shares to a social network; the number of views; the amount of time watched (i.e., how much time was spent in playback); the number of playback through 25%, 50%, 75% and 100%; the number of ad impressions; the number of monetizable views; the number of views per unique user; the amount of time watched per unique user; the average session length (i.e., a pre-determined window of time, such as a week); the number of views per session; the number of ads watched per session; a percentage of total views from each of top referrers (e.g., top four referrers); a percentage of views from top referrers among the total views; a percentages of views from one or more groups of sources (e.g., social networks, search engines, emails); and geography information describing the location of referrers.

The analytics module 480 is communicatively coupled to the analytics store 420. The analytics module 480 communicates with the analytics store 420 to store the determined values for the metrics in the analytics store 420 for later use. In one embodiment the analytics module 480 communicates with the reporting module 485 to transmit the determined values to the reporting module 485.

The reporting module 485 is code and routines for generating reports describing analytics data. The analytics data includes the values for metrics, the text information and the geography information. In one embodiment, a report includes data describing the determined values for the metrics. For example, the report includes one or more of a chart, a statistic or a key statistic (i.e., an important or core statistic for a report), a table and a map that are constructed using the analytics data.

The chart used to display the values for the metrics can be a bar chart, a pie chart, a line chart and any other chart known in web analytics. Also more than one chart can be used to display a value for a metric. The reporting module 485 can also use a chart to display the changes of the values for the metrics from day to day, week to week, month to month, etc.

In another embodiment, the charts included in the reports also describe one or more of the text information and geography information. For example, a chart that displays a comparison of the numbers of views of different versions of a video includes text describing the video version information. Another chart may show geographical distribution of the number of likes for a video by including geography information describing the location of the users who click like buttons. Other charts using the text information and the geography information are possible.

In one embodiment, the reporting module 485 generates statistics and tables using the values for metrics and the text information. For example, the statistics are the percentages of views from a group of sources (e.g., from referrers, from emails, from social networks, from search engine, etc.). The statistics can be key statistics. Key statistics are statistics identified by an administrator as important or core statistics for a report. The tables compare values for metrics. For example, the reporting module 485 generates a table comparing the numbers of shares (e.g., total shares and social shares) between different videos. Then the video ID, name and video version are used to construct the table as well as the values for metrics.

In one embodiment, the geography information is used by the reporting module 485 to generate statistics and tables. For example, a table in a report describes referrers of a video and their geography information. In another embodiment, the geography information is used by the report module 485 to generate a map displaying the geographic locations of referrers, viewers and/or commenters.

In one embodiment, the reporting module 485 also retrieves historical report data or historical analytics data from the analytics store 420 to generate a historical report based on historical data. For example, the reporting module 485 generates a chart comparing the total shares for different versions of a video (e.g., version I, version II and version III) during the first month of publication. Since the publisher publishes version I, II and III of the video at different time (e.g., five months ago, two months ago and one month ago, respectively), the reporting module 485 retrieves historical data and uses this data to generate the historical report. Other historical reports are possible.

In one embodiment, the reporting module 485 includes data describing one or more predefined reports to expedite generation of the reports. The reporting module 485 retrieves data describing the content of predefined reports from the analytics store 420. A predefine report is a report with content predefined by an administrator. For example, a predefined report is a video viewing report with predefined contents such as identifying the number of total views and unique views (e.g., views from unique users) for a video. In another example, a predefined report is a sharing report displaying the numbers of a variety of shares. A predefined report can also be a discovery report showing users how their video is being found by viewers. Specifically, the discovery report includes statistics of views, unique views, views from referrers and the geographical distribution of referrers. The reporting module 485 receives a selection of a predefined report via a communication device 450, retrieves analytics data from the analytic store 420 and generates the selected predefined report.

Alternatively, the reporting module 485 receives user input defining which content should be included in a customized report. A customized report is a report customized based on the requirements of a user. For example, the reporting module 485 receives a communication from a user via the network 150. The communication includes a description of the different metrics, charts, tables, etc to be included in the customized report.

The analytics store 420 is a persistent storage device that stores data received from one or more of a user device 160, a media player 115, the analytics engine 125 and the communication device 450. For example, the analytics store 420 stores one or more of data describing video IDs, data describing video versions and video URLs, metrics for video level events, event data describing video level events, analytics data received from the analytics module 480, report data received from the reporting module 485 and graphics data including graphics used to be shown on a user interface.

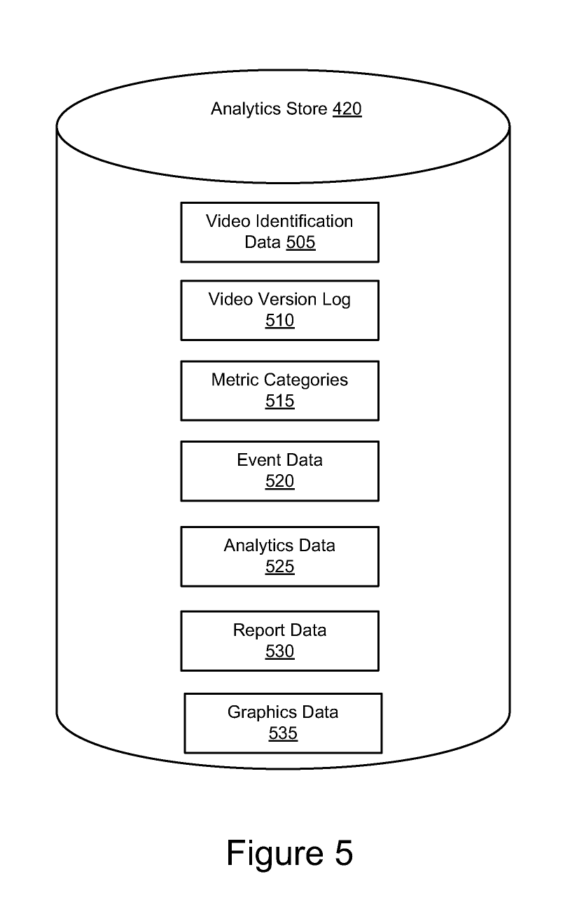

In one embodiment, the analytics store 420 stores analytics data using a visit identifier, so that user interactions with a web page during a visit are maintained according to the visit identifier. The analytics store 420 is described in further detail below with reference to FIG. 5.

The advertisement storage (“ad storage”) 425 is a persistent storage device that stores data for playback of an ad. For example, the ad storage 425 stores one or more ads to be displayed before, during or after playback of a video. In one embodiment, the ad storage 425 stores metadata for an ad (e.g., a title, a keyword and a description for the ad), allowing the ad determination module 465 to determine an ad for a video by matching the metadata of the ad against the metadata of the video. For example, the ad determination module 465 compares a keyword describing the video with keywords for the ads stored in the ad storage 425 and selects an ad with the same keyword as the video. In another embodiment, the ad storage 425 stores rules for displaying advertisements as pre-roll ads (e.g., ads played before playing a video), mid-roll ads (e.g., ads played in the middle of playing a video) and post-roll ads (e.g., ads played after playing a video).

### Analytics Store 420

FIG. 5 is a block diagram illustrating one embodiment of the analytics store 420. In the depicted embodiment, the analytics store 420 includes video identification data 505, a video version log 510, metric categories 515, event data 520, analytics data 525, report data 530 and graphics data 535. Persons of ordinary skill in the art will recognize that the analytics store 420 may store additional data not depicted in FIG. 5, such as location data for a video, domain restriction data for a media player 115 and other data to provide functionalities described herein.

The video identification data 505 is data identifying a video. In one embodiment, the video identification data 505 includes one or more of a unique video ID that distinguishes a video from another video, a publisher, a published time and a title for a video.

The video version log 510 is a log of data describing different versions for the videos identified by the video identification data 505. For example, the request module 291 of a media player 115 generates a request. The request module 291 identifies a video being played on the media player 115 by including the video ID for that video in the generated request. The request also includes an identifier describing the version of the video (e.g., the first, second or third version of a video) being played on the media player 115. In one embodiment, the request also includes event data describing a video level event that occurred before, during or after playback of the video identified by the video ID. The ping module 290 sends the request to the analytics server 123 via the network 150. The video identification data 505 stores the video ID and the video version log 510 stores the corresponding video version identifier that describes the version of the video. In one embodiment, one or more of the video identification data 505 and the video version log 510 store an association between the video ID and one or more video version identifiers that correspond to the video identified by the video ID. In another embodiment, the video version log 510 stores associations between the video version identifiers and the event data describing the video level event that occurred before, during or after playback of the video identified by the video ID. In this way, the video version log 510 stores data used by the analytics server 123 to determine how video level events correspond to different versions of a video. In yet another embodiment, the video version log 510 includes video version identifiers for all the different versions of the videos identified by the video IDs stored in the video identification data 505 and associations between the video versions identifiers and the event data describing video level events for those video versions.

The metric categories 515 are data describing metrics for video level events. For example, the metric categories 515 stores a list including all the metrics for video level events received from the analytics engine 125. In one embodiment, the metric categories 515 stores metrics for video level events in one of a list, a table, a queue and/or any other data structure.

The event data 520 are data describing video level events. For example, the event data 520 describes all the video level events received by the analytics engine 125 during a predetermined period of time (e.g., a year).

The analytics data 525 are data received from the analytics engine 125. For example, the analytics data 525 are one or more of values for metrics, text information and geography information determined by the analytics engine 125. In one embodiment, the analytics data 525 provide a basis for generating a report to a user (e.g., a publisher). For example, the reporting module 485 retrieves the analytics data 525 based at least in part on predetermined parameters for a report or requests from a user and generates a report using the analytics data 525.

The report data 530 are data describing reports generated by the reporting module 485. The reports include at least two types of reports, i.e., predefined reports and customized reports. In each type, the reports can be sharing reports, discovery reports, comparison reports, daily reports, year-end reports, etc. In one embodiment, the report data 530 also include data describing predefined reports. In another embodiment, the report data 530 include report templates for all styles. In yet another embodiment, the report data 530 are saved for a predetermined period of time. For example, the reporting module 485 uses historical reports to generate new reports, such as year-end reports and comparison reports for a set of different time periods.

The graphics data 535 are graphical data used by the reporting module 485 to perform its function. For example, the graphics data 535 includes graphical data used by the reporting module 485 to generate reports, charts, maps, pictures and any other graphics necessary for the reporting module 485 to perform its function.

### Event Diagrams

Referring now to FIGS. 6A-6C depict event diagrams depicting various events in accordance with one embodiment. FIGS. 6A-6C are described below.

FIG. 6A describes events for playback of a video having a pre-roll advertisement in accordance with one embodiment. The user device 160 loads 602 a media player 115 for presenting a video to a user. The media player 115 transmits 604 a load request to the analytics engine 125. The load request is generated by the media player 115 responsive to a status of loading on the user device 160. The load request includes event data describing the media player 115 loading on the user device 602.

The analytics engine 125 receives the load request from the user device 160. The analytics engine 125 determines 606 an ad to be played and sends the ad to the media player 115. For example, the ad determination module 465 comprised within the analytics engine 125 determines an ad for the video by retrieving an ad stored in the ad storage 425 that matches a keyword of the video. The media player 115 receives 608 the data stream for the ad from the analytics engine 125. Steps 606 and 608 are depicted using dashed lines to indicate that they are optional features. In one embodiment, the media player 115 receives the data stream for an ad from one of the third party ad server 190 and the ad server 140.

The ad begins 610 playing in the media player 115. Since the ad is played before viewing the video, the ad is a pre-roll ad. The media player 115 sends 612 an ad start request to the analytics engine 125. The ad start request includes event data describing that the pre-roll ad has started playback. In one embodiment, the ad start request includes event data describing other video level events that have occurred since the last request was sent (e.g., the user mouses over a portion of the media player, the user moves the media player so that it is on a different portion of the display, the user changes the size or the media player, etc.).

While playing the pre-roll ad, the media player 115 sends 614 an ad progress request to the analytics engine 125 at predetermined intervals defined by an administrator (e.g., every two seconds). The ad progress request includes event data describing how much of the ad has been played back on the media player 115 and any other video level events that have occurred since the last request was sent to the analytics engine 125. The media player 115 sends 616 one or more ad checkpoint requests to the analytics engine 125 at one or more checkpoints such as playback of 25%, 50%, 75% and 100% of the total length of the ad. The ad checkpoint request includes event data describing the percentage of the ad that has been played back on the media player 115 and any other video level events that occurred since the last request was sent to the analytics engine 125. If the ad completes 618 playing without abandonment, the media player 115 sends 620 an ad end request to the analytics engine 125 to indicate completion of playing the ad. The ad end request includes event data describing that the entire ad was played back on the media player 115 and any other video level events that occurred since the last request was sent to the analytics server 125.

After the completion of playing the ad, the media player 115 sends 622 a view request to the analytics engine 125 to indicate video playback has begun. The view request includes event data describing that the video has begun playback and any other video level events that occurred since the last request was sent to the analytics server 125.

The playback of the video begins 624. The media player 115 sends 626 a video progress request to the analytics engine 125 at predetermined intervals. The video progress request includes event data describing how much of the video has been played back and any other video level events that occurred since the last request was sent to the analytics server 125. Additionally, the media player 115 also sends 628 one or more view checkpoint requests to the analytics engine 125 at one or more checkpoints such as playback of 25%, 50%, 75% and 100% of the total length of the video. The view checkpoint request includes event data describing the percentage of the video that has been played back on the media player 115 and any other video level events that occurred since the last request was sent to the analytics engine 125.

When the video completes playing, the media player 115 sends 630 a view end request to the analytics engine 125 to indicate completion of playing the video. The view end request includes event data describing that playback of the video has ended and describing any other video level events that occurred since the last request was sent to the analytics engine 125.

The descriptions for the different requests described above for FIG. 6A are the same for FIGS. 6B and 6C, so these descriptions will not be repeated when describing FIGS. 6B and 6C.

FIG. 6B describes events for playback of a video having a mid-roll advertisement (e.g., an overlay ad) in accordance with one embodiment. The user device 160 loads 632 a media player 115 for presenting a video to a user. The media player 115 transmits 634 a load request to the analytics engine 125. The media player 115 sends 636 a view request to the analytics engine 125. The playback of the video begins 638. The media player 115 sends 640 one or more view progress requests to the analytics engine 125 at one or more predetermined intervals. The media player 115 sends 642 one or more view checkpoint requests to the analytics engine 125.

The analytics engine 125 determines 644 an ad to be played for the video. The media player 115 receives 646 a data stream for playing the ad from the analytics engine 125. Steps 640-646 are depicted using dashed lines to indicate that they are optional features to the method. In one embodiment, the media player 115 receives data stream for an ad from one of the third party ad server 190 and the ad server 140.

Responsive to receiving the data stream for the ad, playback of the video in the media player 115 pauses 648. The media player 115 sends 650 a view pausing request to the analytics engine 125 to indicate that the video is paused in the media player 115. The view pausing request includes event data describing the pausing of video playback and event data describing any video level events that have occurred since the last request was sent to the analytics engine 125. The media player 115 buffers the data stream for the ad and the ad begins 652 to play. Since the ad is played in the middle of playing the video, the ad is referred to as a mid-roll ad. The media player 115 sends 654 an ad start request to the analytics engine 125. The media player 115 also sends 656 an ad progress request to the analytics engine 125 at predetermined intervals. The media player 115 sends 658 one or more ad checkpoint requests to the analytics engine 125. The media player 115 sends 662 an ad end request to the analytics engine 125 to indicate completion of playing the ad 660.

When the ad completes playing, the playback of the video continues 664 and the media player 115 sends 666 a view continuing request to the analytics engine 125 to indicate continuing to play the video. The view continuing request includes event data describing that playback of the video has resumed. The view continuing request also includes event data describing any video level events that have occurred since the last request was sent. For example, the event data describes how the user interacted with the ad, such as muting the volume during playback of the ad, minimizing the screen of the advertisement during playback of the ad, clicking links and taking steps to purchase a product featured in the ad, etc.

The media player 115 sends 668 a view progress request to the analytics engine 125. The media player 115 sends 670 one or more view checkpoint requests to the analytics engine 125 at one or more checkpoints. The media player 115 sends 672 a view end request to the analytics engine 125.

FIG. 6C describes events for playback of a video having a post-roll advertisement (e.g., ads played after playing a video) in accordance with one embodiment.

FIG. 6C illustrates an event diagram of a method for capturing requests from a media player 115 according to yet another embodiment. The user device 160 loads 674 a media player 115. The media player 115 transmits 676 a load request to the analytics engine 125. The media player 115 sends 678 a view request to the analytics engine 125. The playback of the video begins 680. The media player 115 sends 682 a view progress request to the analytics engine 125 at predetermined intervals. The media player 115 sends 684 one or more view checkpoint requests to the analytics engine 125. The media player 115 sends 686 a view end request to the analytics engine 125 to indicate completion of playing the video.

Responsive to receiving the view end request, the analytics engine 125 determines 688 an ad to be played. The media player 115 receives 689 the ad data stream from the analytics engine 125. Steps 688 and 689 are depicted using dashed lines to indicate that they are optional features of the method. In one embodiment, the media player 115 receives data stream for an ad from one of the third party ad server 190 and the ad server 140.

The media player 115 buffers the data stream for the ad. The ad begins 690 to play. Since the ad is played after viewing the video, the ad is referred to as a post-roll ad. The media player 115 sends 691 an ad start request to the analytics engine 125. The media player 115 sends 692 an ad progress request to the analytics engine 125 at predetermined intervals. The media player 115 sends 694 one or more ad checkpoint requests to the analytics engine 125. If the ad completes 696 playing without abandonment, the media player 115 sends 698 an ad end request to the analytics engine 125.

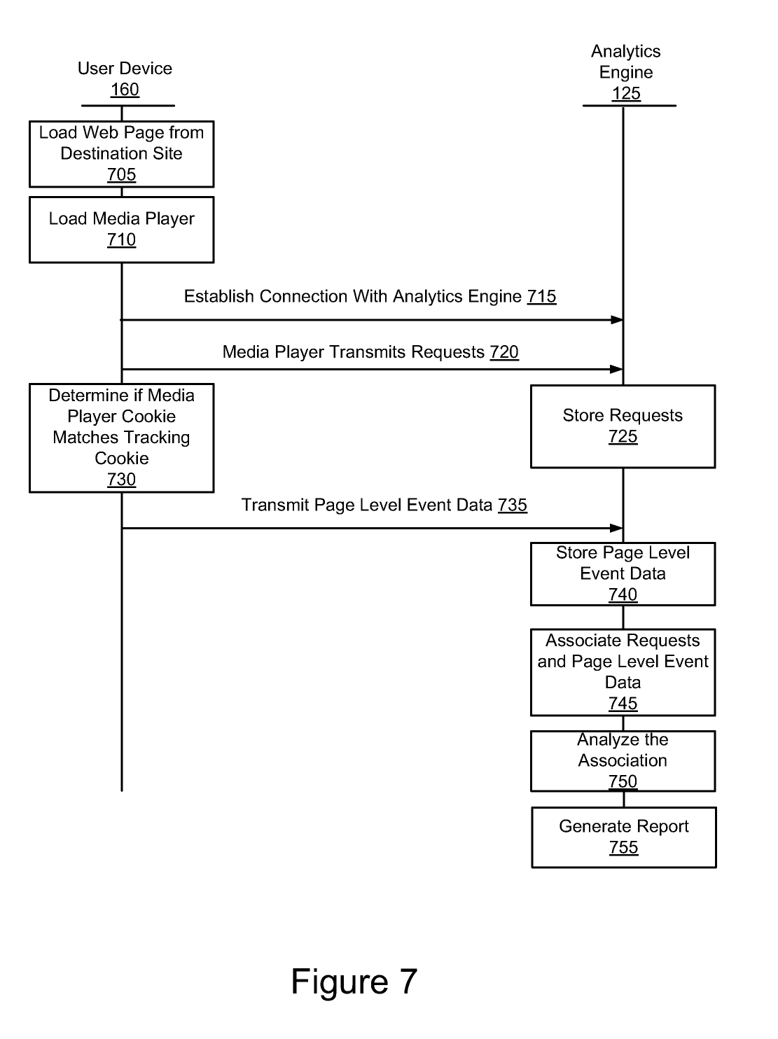

FIG. 7 illustrates an event diagram of a method for capturing requests and video level events that are generated by the media player 115 according to one embodiment. In the example shown by FIG. 7, the user device 160 receives a web page including video data from a destination site 170. Upon receiving the web page, the user device 160 loads 705 the web page. For example, the user device 160 executes data, such as a structured document, to display the web page from the destination site 170. While loading the web page, the user device 160 loads 710 a media player 115 included in the web page. For example, the user device 160 executes embed code included in the web page, causing the media player 115 to be loaded.

When the media player 115 has been loaded, the media player 115 establishes 715 a connection with the analytics engine 125 via the network 150. Using the established connection, the media player 115 transmits 720 various requests to the analytics engine 125. In one embodiment, the media player 115 transmits a request to the analytics engine 125 at predetermined intervals. For example, the media player 115 transmits a view progress request to the analytics engine 125 every 10 seconds when playing the video. In another embodiment, the media player 115 transmits a request to the analytics engine 125 responsive to a status change of the media player 115. For example, the media player 115 transmits a view end request to the analytics engine 125 in response to the completion of playing a video.

The analytics engine 125 stores 725 the requests in the analytics store 420. As the media player 115 transmits additional requests, the analytics engine 125 stores the additional requests. In addition to storing requests, the analytics engine 125 also stores video level event data (i.e. event data describing video level event) if the website maintained by the destination site 170 is also monitored by the analytics engine 125. However, even if the website maintained by the destination site 170 is not monitored by the analytics engine 125, the requests are stored to allow monitoring and analyzing interactions with video data.

To determine whether the website maintained by the destination site 170 from which the web pages are also monitored by the analytics engine 125, the media player 115 determines 730 whether a tracking cookie included in the web page matches a media player cookie associated with the media player 115. If a website is being tracked by the analytics engine 125, web pages comprising the web site include a tracking cookie. In one embodiment, the tracking cookie included in the web page is a first party cookie. For example, the tracking cookie is associated with a domain used by the destination site 170 to maintain the website. The tracking cookie included in a web page monitored by the analytics engine 125 includes a visitor identifier, a visit identifier, a user identifier and data associated with the web page.

However, the analytics engine 125 uses a third-party cookie for the media player cookie. The third-party media player cookie is associated with a domain that differs from the domain used by the destination site 170 to maintain the website. For example, the media player cookie is associated with a domain related to the analytics engine 125. By using a third-party cookie as the media player cookie, the analytics engine 125 allows access to the video data presented by the media player 115 to be monitored across different domains. Hence, the third-party media player cookie includes a user identifier that is the same across different websites that present the video data allowing data to be captured about interactions for video data even if the video data is copied to different websites.

Hence, to determine 730 if the tracking cookie matches the media player cookie, the media player 115 determines whether the user identifier of the tracking cookie matches the user identifier of the media player cookie. If the media player 115 determines that the tracking cookie matches the media player cookie, interactions with the web page are transmitted 735 from the user device 160 to the analytics engine 125 via the network 150. By determining if the user identifier of the tracking cookie and the user identifier of the media player cookie match, the media player 115 initially determines whether the website and the video data are commonly owned before transmitting video level event data to the analytics server 125. Additionally, if the media player 115 determines that the user identifier of the tracking cookie and the user identifier of the media player cookie match, the media player 115 associates a session identifier with the tracking cookie and the media player cookie.

If video level event data is received, the analytics server 125 stores 740 the video level event data in the analytics store 420 and associates 745 the stored requests with the stored video level event data. Thus, the analytics server 125 separately receives the video level event data and the requests and then associates the video level event data and the requests. For example, the analytics engine 125 associates requests and video level event data using the session identifier associated with the tracking cookie and the media player cookie. Associating requests from the media player 115 and video level event data using the session identifier allows the analytics store 420 to maintain data describing different sessions that include video level event data and requests.

Upon the association of the stored video level event data and requests, the analytics module 480 of the analytics engine 125 analyzes 750 the association. For example, the analytics module 480 calculates values for metrics (e.g., total shares, email shares, views, time watched, percentage of views from top referrers, etc.) and extracts text information and geography information from the association of the video level event data and requests. Based at least in part on the analysis, the reporting module 485 of the analytics engine 125 generates 755 a report. For example, the reporting module 485 constructs charts, tables and statistics using the analytics results (e.g., the values for metrics, the text and geography information).

However, if the media player 115 determines 730 that the media player cookie does not match the tracking cookie, video level event data is not transmitted to the analytics engine 125. For example, if the media player 115 determines that the user identifier of the tracking cookie does not match the user identifier of the media player cookie, video level event data is not transmitted. Thus, even if the website from which the video data is accessed by the user device 160 is not being monitored by the analytics engine 125, the analytics engine 125 still stores 725 requests to enable monitoring of interactions with video data.

### Methods

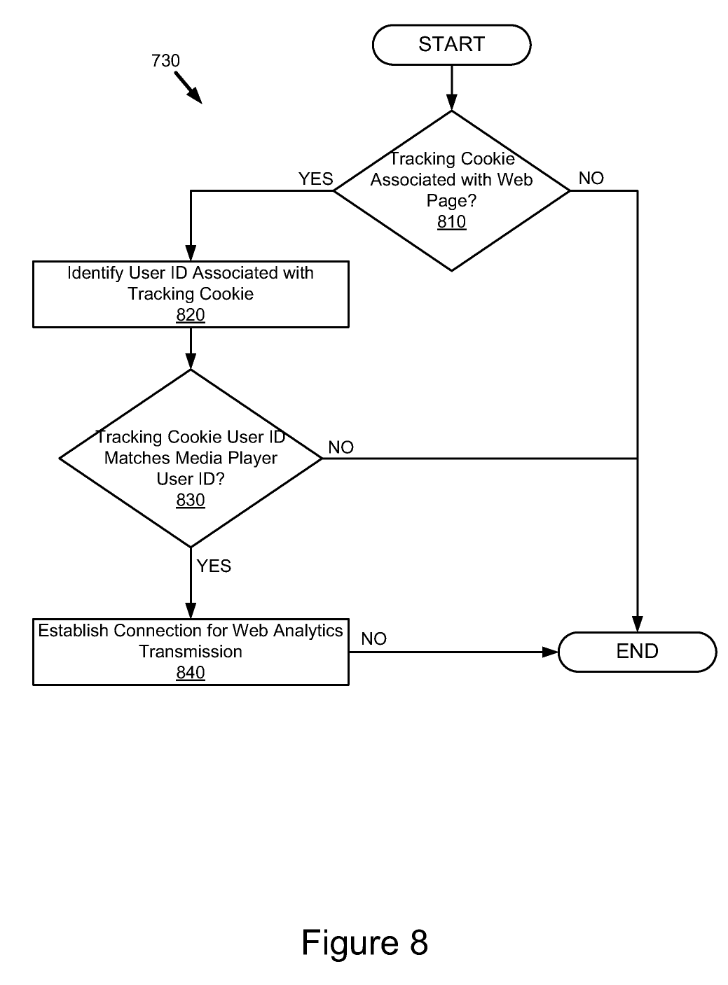

FIG. 8 is a flow diagram illustrating one embodiment of a method 730 for determining whether a media player cookie matches a web page tracking cookie. In one embodiment, the steps identified by FIG. 8 are performed by the media player 115 executing on the user device 160.

Initially, the media player 115 determines 810 whether a tracking cookie is associated with the web page in which the media player 115 is launched. For example, the media player 115 places a call to the web page to identify the web page tracking cookie. If no information identifying the web page tracking cookie is received from the web page or if the media player 115 is otherwise unable to identify the web page tracking cookie, the method ends. Accordingly, video level event data is not transmitted to the analytics engine 125 because the web page is not being monitored by the analytics engine 125; however, requests from the media player 115 are transmitted to the analytics engine 125 to allow monitoring of interactions for video data.

However, if the media player 115 determines 810 that a web page tracking cookie is associated with the web page, the media player 115 identifies 820 a user identifier (“user ID”) associated with the web page tracking cookie. For example, the web page communicates the web page tracking cookie or data identifying the web page tracking cookie to the media player 115. The media player 115 then identifies 820 the user identifier associated with the web page tracking cookie. Alternatively, the web page identifies 820 the user identifier associated with the web page tracking cookie.

The media player 115 then determines 830 whether the user identifier associated with the web page tracking cookie matches a user identifier associated with the media player cookie. If the user identifier associated with the web page tracking cookie does not match a user identifier associated with the media player cookie, the method ends and video level event data is not transmitted to the analytics engine 125. For example, if the user identifier associated with the web page tracking cookie differs from the media player cookie, the web page and the media player 115 are owned by different entities so that video level event data is not transmitted. However, the requests from the custom media player 115 are transmitted to the analytics engine 125.

Responsive to the user identifier associated with the web page tracking cookie matching the user identifier associated with the media player cookie, the media player 115 initiates a command to establish 840 a connection between the user device 160 and the analytics engine 125. In one embodiment, the media player 115 associates a session identifier with the tracking cookie and the media player cookie. The session identifier is included with the video level event data and the requests transmitted to the analytics engine 125. Associating a session identifier with the requests and the video level event data allows the analytics engine 125 to associate the received video level event data and requests with each other in a session that includes video level event data and requests.

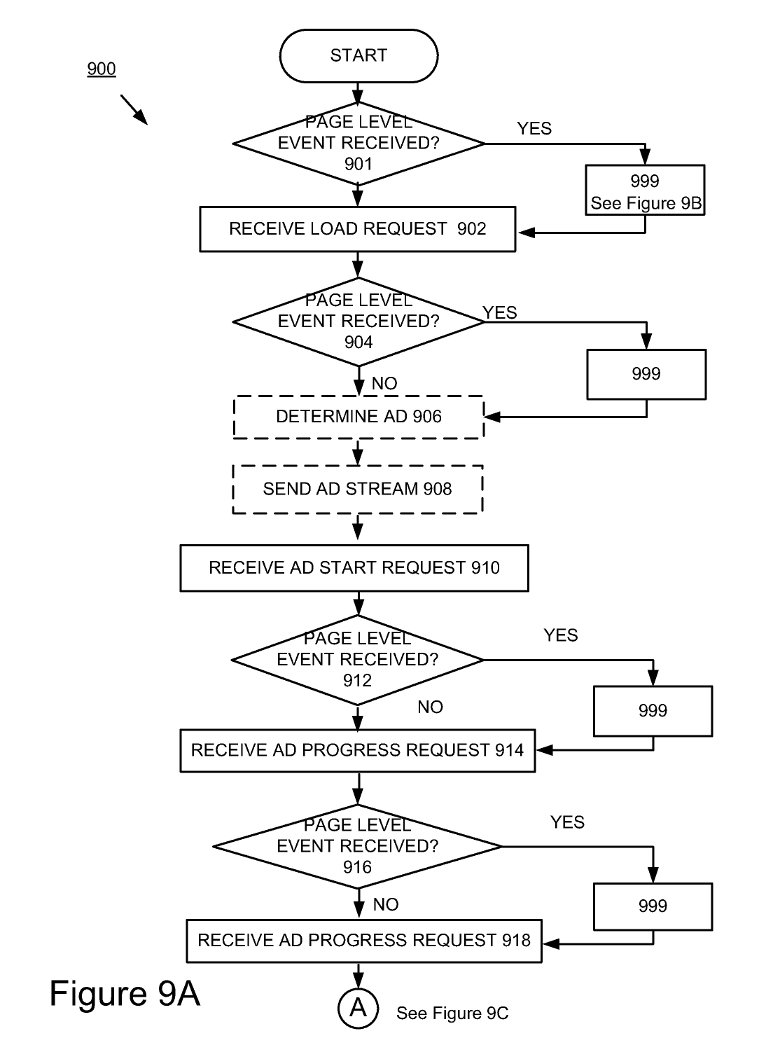

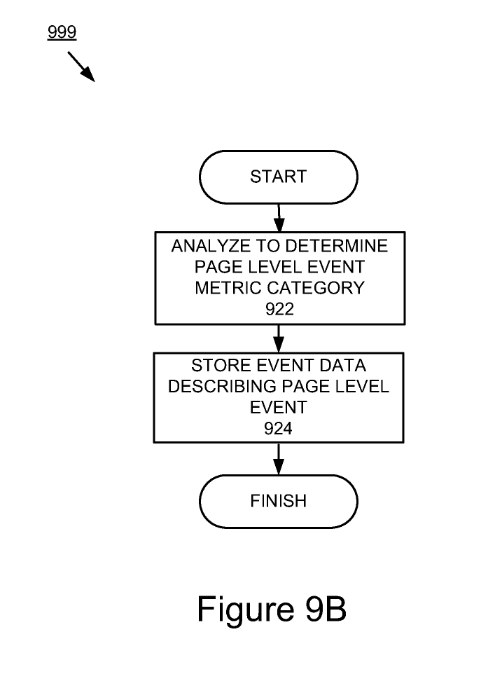

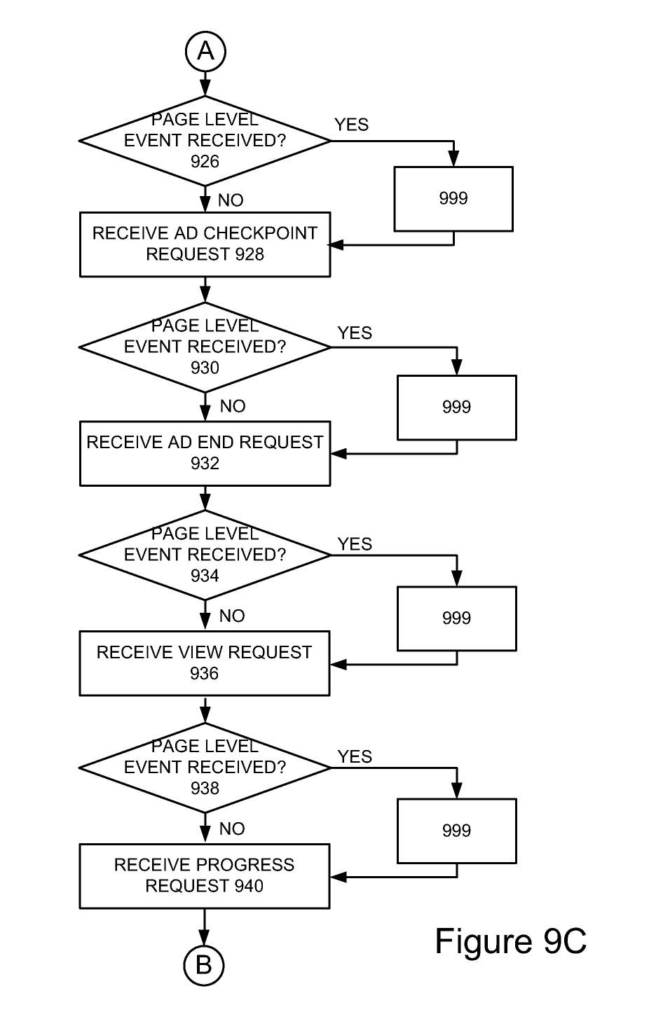

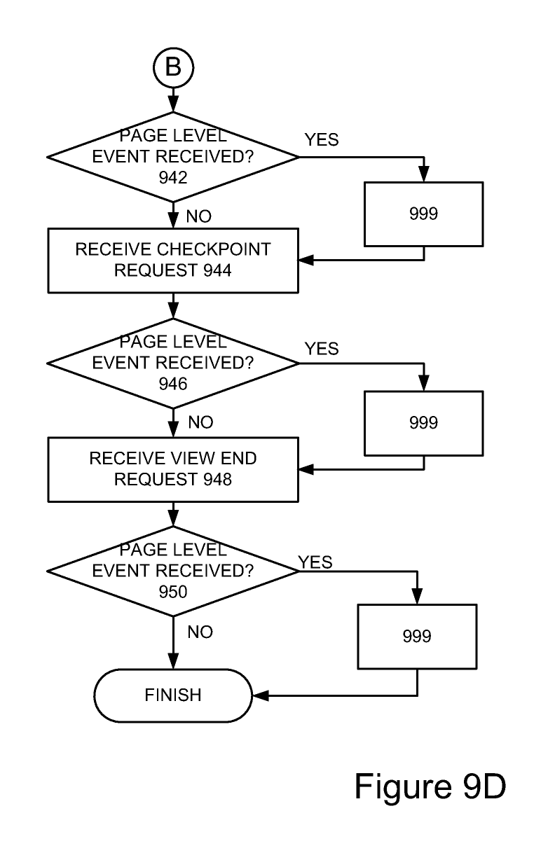

FIGS. 9A-9D are flow diagrams illustrating one embodiment of a method 900 for capturing video level events in requests and video level events separate from requests sent by a media player 115. Turning to FIG. 9A, the request analysis module 470 determines 901 whether a video level event is received. If a video level event is received, the method 900 moves to a sub-routine 999 depicted in FIG. 9B and described below. Otherwise, the method 900 moves to a step 902.

Referring to FIG. 9B, the sub-routine 999 is illustrated according to one embodiment. The request analysis module 470 analyzes 922 the video level event to determine video level event type. For example, the request analysis module 470 determines video level event type (e.g., the category for the video level event). For example, the request analysis module 470 determines video level event type corresponding to one or more metrics (such as the number of total shares, the number of views, etc.). The request analysis module 470 then stores 924 event data describing video level event in the analytics store 420. The event data are stored based at least in part on the video level event type in one embodiment and based on other factors, such as a time order and a priority determined by the user who asks for a report, in another embodiment.

After step 924, the subroutine 999 ends and the method 900 reverts to the step in the method 900 that succeeds execution of the subroutine 999. For example, if the step preceding execution of the subroutine 999 is step 901, the method 900 returns to step 902 after the subroutine 999 is completed (e.g., after step 924 is completed). If the step preceding execution of the subroutine 999 is step 904, the method 900 returns to step 906 after the subroutine 999 is completed. If the step preceding execution of the subroutine 999 is step 912, the method 900 returns to step 914 after the subroutine 999 is completed. A person having ordinary skill in the art will recognize how this applies to the other steps of the method 900.

Referring back to FIG. 9A, at step 902 the request analysis module 470 receives 902 a load request from the media player 115. In one embodiment, the request analysis module 470 receives the load request via the communication module 460. The request analysis module 470 parses the load request and determines 904 whether a video level event is included in the load request. For example, the request analysis module 470 determines whether a video level event such as a pop out is included in the load request. If a video level event is detected, the method 900 moves to a sub-routine 999. Otherwise, the method 900 moves to a step 906.

At step 906, the ad determination module 465 determines an ad to serve to the media player 115. The ad determination module 465 sends 908 the data stream for the ad to the media player 115. Steps 906 and 908 are depicted using dashed lines to indicate that they are optional features of the method 900. In one embodiment, the media player 115 receives data stream for an ad from one of the third party ad server 190 and the ad server 140.

The ad starts to play in the media player 115. The request analysis module 470 receives 910 an ad start request from the media player 115 and determines 912 whether a video level event is included in the ad start request. If a video level event is included, the method 900 moves to the sub-routine 999. If a video level event is not included, the method 900 moves to step 914.

At step 914, the request analysis module 470 receives an ad progress request from the media player 115. The request analysis module 470 determines 916 whether a video level event is included in the ad progress request. If a video level event is included, the method 900 moves to the sub-routine 999. If a video level event is not included, the method 900 moves to step 918.

At step 918, the request analysis module 470 receives an ad checkpoint request from the media player 115.

Referring to FIG. 9C, the request analysis module 470 determines 930 whether a video level event is included in the ad checkpoint request. If a video level event is included, the method 900 moves to the sub-routine 999. If a video level event is not included, the method 900 moves to step 932.

When the ad completes playing without abandonment, the request analysis module 470 receives 932 an ad end request from the media player 115. The request analysis module 470 determines 934 whether a video level event is included in the ad end request. If a video level event is included, the method 900 moves to the sub-routine 999. If a video level event is not included, the method 900 moves to step 936.

When the video starts to play in the media player 115, the request analysis module 470 receives 936 a view request from the media player 115. The request analysis module 470 determines 938 whether a video level event is included in the view request. If a video level event is included, the method 900 moves to the sub-routine 999. If a video level event is not included, the method 900 moves to step 940. At step 940, the request analysis module 470 receives a view progress request from the media player 115. In one embodiment, the media player 115 sends a view progress request to the request analysis module 470 in predetermined intervals.

Referring to FIG. 9D, the request analysis module 470 determines 942 whether a video level event is included in the view progress request. If a video level event is included, the method 900 moves to the sub-routine 999. If a video level event is not included, the method 900 moves to step 944.

At step 944, the request analysis module 470 receives a view checkpoint request from the media player 115. In one embodiment, the media player 115 sends one or more view checkpoint requests to the request analysis module 470 at one or more checkpoints such as 25%, 50%, 75% and 100% of the video. The request analysis module 470 determines 946 whether a video level event is included in the view checkpoint request. If a video level event is included, the method 900 moves to the sub-routine 999. If a video level event is not included, the method 900 moves to step 948.

When the video completes playing without abandonment, the request analysis module 470 receives 948 a view end request from the media player 115. The request analysis module 470 determines 950 whether a video level event is included in the view end request. If a video level event is included, the method 900 moves to the sub-routine 999. If a video level event is not included, the method 900 ends. In one embodiment, the request analysis module 470 keeps monitoring video level event after receiving the view end request. In another embodiment, if in any of the received requests a click through to a new web page/video is detected, the method 900 ends.

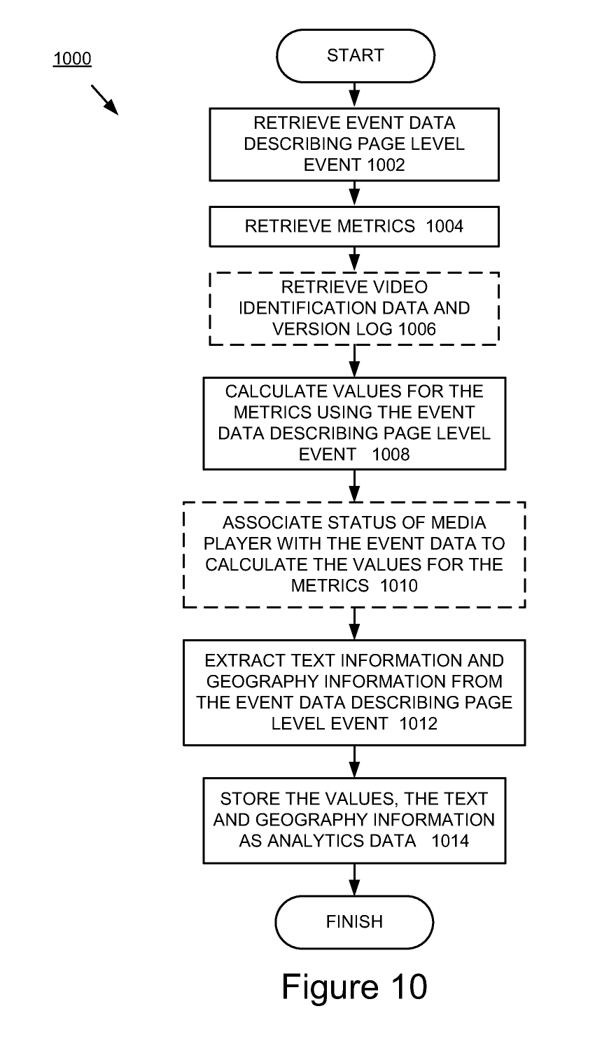

FIG. 10 is a flow chart of one embodiment of a method 1000 for analyzing event data. In the example shown by FIG. 10, the analytics module 480 retrieves 1002 event data describing video level event from the analytics store 420. In one embodiment, the analytics module 480 performs step 10002 periodically at a time interval (e.g., a day, a week, a month, a season, etc.) defined by an administrator. In other examples, step 10002 is triggered by a request of a user (e.g., a publisher). In one embodiment, the event data are stored based on video level event type. In another embodiment, the event data are stored based on the time when the event data is received.

The analytics module 480 retrieves 1004 metrics from the analytics store 420. For example, responsive to receiving a request (e.g., a request for a video sharing report) from a publisher for a report, the analytics module 480 retrieves metric data such as total shares, social shares, email shares, embed copies, shares to one or more social networks, etc.

The analytics module 480 retrieves 1006 video identification data and version log from the analytics store 420 according to a request of a user or an administrator. Step 1006 is depicted in FIG. 10 with a dashed line to indicate that this step is an optional feature of the method 1000.

The analytics module 480 calculates 1008 values for the metrics using the event data describing video level event. For example, the analytics module 480 calculates that 13% of users who viewed a first version of video A shared video A, and that 39% of users who viewed a second version of video A shared video A. From this the publisher of video A can determine that the second version of video A is more desirable to users.

The analytics module 480 associates 1010 a status of media player 115 with the event data to calculate the values for the metrics. For example, to calculate the time watched for a video, the status of the media player is associated with the event data to determine the actual view time for the video. An indication that the web page including a video is not viewable on a user's display, for example, can indicate that the video is not being viewed although it is still playing on the media player 115. In one embodiment, the analytics module 480 uses this data to discount this time from the total view time of the video since the time when the video is not on the display cannot be included in the metric describing the time watched for the video. Step 1010 is depicted in FIG. 10 with a dashed line to indicate that this step is an optional feature of the method 1000.

At step 1012, the analytics module 480 extracts text information and geography information from the event data describing video level event. In one embodiment, the analytics module 480 also determines 1012 approval indications in comments. The analytics module 480 stores 1014 the values, the text and geography information as analytics data in the analytics store 420.

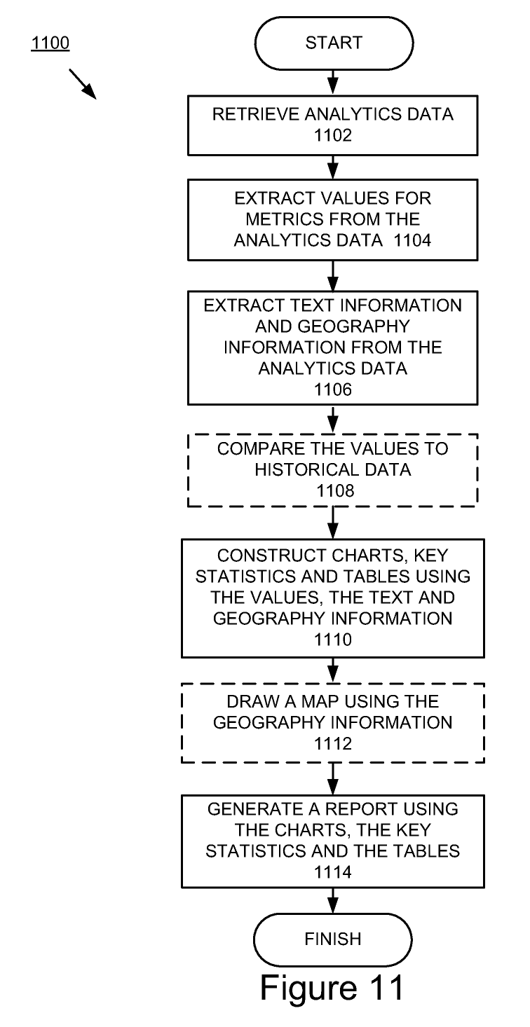

FIG. 11 is a flow chart of one embodiment of a method 1100 for generating a report. The reporting module 485 retrieves 1102 analytics data from the analytics store 420. The reporting module 485 extracts 1104 values for metrics and extracts 1106 text information and geography information from the analytics data.

In one embodiment, for a report including a comparison to data for past time, the reporting module 485 compares 1108 the values to historical data. Step 1108 is depicted with a dotted line to indicate that it is an optional feature of the method 1100.

The reporting module 485 constructs 1110 charts, key statistics (e.g., important or core statistics that can be different for different reports) and tables using the values, the text information and the geography information. The reporting module 485 generates 1112 a map based at least in part on the geography information.

The reporting module 485 generates 1114 a report using one or more of the charts, the key statistics and the tables. In one embodiment, the report also includes one or more maps. In another embodiment, the reporting module 485 arranges one or more of the charts, the key statistics and the tables based at least in part on an input from a user including a style selection.

The foregoing description of the embodiments has been presented for the purposes of illustration and description. It is not intended to be exhaustive or to limit the present embodiments to the precise form disclosed. Many modifications and variations are possible in light of the above teaching. It is intended that the scope of the present embodiments be limited not by this detailed description, but rather by the claims of this application. As will be understood by those familiar with the art, the present embodiments may be embodied in other specific forms without departing from the spirit or essential characteristics thereof. Likewise, the particular naming and division of the modules, routines, features, attributes, methodologies and other aspects are not mandatory or significant, and the mechanisms that implement the present embodiments or its features may have different names, divisions and/or formats. Furthermore, as will be apparent to one of ordinary skill in the relevant art, the modules, routines, features, attributes, methodologies and other aspects of the present embodiments can be implemented as software, hardware, firmware or any combination of the three. Also, wherever a component, an example of which is a module, of the present embodiments is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present embodiments are in no way limited to implementation in any specific programming language, or for any specific operating system or environment. Accordingly, the disclosure is intended to be illustrative, but not limiting, of the scope of the embodiments, which is set forth in the following claims.

1. A method for providing web analytics for video level events, the method comprising:
receiving, by a server, a version identifier of a first version of a video and first event data, the first event data describing a first video level event comprising a user interaction with a media player on a user device, the user interaction changing at least one of a volume of the media player or a location of the media player on a display of the user device;
receiving a checkpoint message comprising the version identifier and second event data, the second event data describing a second video level event comprising a progress of the media player in presenting the first version of the video on the user device; and
analyzing, by the server, the first event data and the second event data to determine a value for one or more metrics that quantify the performance of the first version of the video; and
comparing, by the server, the performance of the first version of the video on the user device with a performance of a second version of the video on another user device, wherein the comparing comprises a comparison of the value with a value quantifying the performance of the second version of the video.

2. The method of claim 1, wherein the first video level event comprises an activity that occurs before, during or after a view of the first version of the video in a web page.

3. The method of claim 1, wherein the first video level event further comprises an indication that a user input changes the size of the media player by maximizing or minimizing the size of the media player on the display of the user device.

4. The method of claim 1, wherein the first video level event further comprises a user interaction with a web page that includes one or more videos.

5. The method of claim 1, wherein the first video level event further comprises one or more of: a user providing an input to cause the first version of the video to begin playback; a user providing an input to change a volume setting for the first version of the video; a user moving a mouse over a portion of the first version of the video; a user provides an input to maximize a size of video playback; a user provides an input to pause playback of the first version of the video; a user provides an input to stop playback of the first version of the video; a user provides an input to have a social interaction with the first version of the video; a user provides an input to pop-out a screen of the media player; a user provides an input to navigate a playlist; and a user provides a subscription input.

6. The method of claim 5, wherein the social interaction includes one or more of liking the first version of the video, favoriting the first version of the video, sharing the first version of the video and commenting on the first version of the video.

7. The method of claim 1, further comprising generating a report based at least in part on values for the one or more metrics.

8. A computer program product comprising a non-transitory computer readable medium comprising instructions that, when executed by a processor, cause the processor to:
receive, by the processor, a version identifier of a first version of a video and first event data, the first event data describing a first video level event comprising a user interaction with a media player on a user device, the user interaction changing at least one of a volume of the media player or a location of the media player on a display of the user device;
receive, by the processor, a checkpoint message comprising the version identifier of the first version of the video and second event data, the second event data describing a second video level event comprising a progress of the media player in presenting the first version of the video on the user device;
analyze, by the processor, the first event data and the second event data to determine a value for one or more metrics that quantify the performance of the first version of the video; and
compare, by the processor, the performance of the first version of the video on the user device with a performance of a second version of the video on another user device, wherein the comparing comprises a comparison of the value with a value quantifying the performance of the second version of the video.

9. The computer program product of claim 8, wherein the first video level event comprises an activity that occurs before, during or after a view of the first version of the video in a web page.

10. The computer program product of claim 8, wherein the first video level event further comprises an indication that a user input changes the size of the media player by maximizing or minimizing the size of the media player on the display of the user device.

11. The computer program product of claim 8, wherein the first video level event further comprises a user interaction with a web page that includes one or more videos.

12. The computer program product of claim 8, wherein the first video level event further comprises one or more of: a user providing an input to cause the first version of the video to begin playback; a user providing an input to change a volume setting for the first version of the video; a user moving a mouse over a portion of the first version of the video; a user providing an input to maximize a size of video playback; a user providing an input to pause playback of the first version of the video; a user providing an input to stop playback of the first version of the video; a user providing an input to have a social interaction with the first version of the video; a user providing an input to pop-out a screen of the media player; a user providing an input to navigate a playlist; and a user providing a subscription input.

13. The computer program product of claim 12, wherein the social interaction includes one or more of liking the first version of the video, favoriting the first version of the video, sharing the first version of the video and commenting on the first version of the video.

14. A system for providing web analytics describing video level events, the system comprising:
a memory; and
a processing device communicably coupled to the memory, the processing device to execute instructions to:
receive from a network a version identifier of a first version of a video and first event data, the first event data describing a first video level event comprising a user interaction with a media player on a user device, the user interaction changing at least one of a volume of the media player or a location of the media player on a display of the user device;
receive from the network a checkpoint message comprising the version identifier and second event data, the second event data describing a second video level event comprising a progress of the media player in presenting the first version of the video on the user device; and
analyze, by the server, the first event data and the second event data to determine a value for one or more metrics that quantify the performance of the first version of the video; and
compare, by the server, the performance of the first version of the video on the user device with a performance of a second version of the video on another user device, wherein the comparing comprises a comparison of the value with a value quantifying the performance of the second version of the video.

15. The system of claim 14, wherein the first video level event comprises an activity that occurs before, during or after a view of the first version of the video in a web page.

16. The system of claim 14, wherein the first video level event further comprises an indication that a user input changes the size of the media player by maximizing or minimizing the size of the media player on the display of the user device.

17. The system of claim 14, wherein the first video level event further comprises a user interaction with a web page that includes one or more videos.

18. The system of claim 14, wherein the first video level event further comprises one or more of: a user providing an input to cause the first version of the video to begin playback; a user providing an input to change a volume setting for the first version of the video; a user moving a mouse over a portion of the first version of the video; a user providing an input to maximize a size of video playback; a user providing an input to pause playback of the first version of the video; a user providing an input to stop playback of the first version of the video; a user providing an input to have a social interaction with the first version of the video; a user providing an input to pop-out a screen of the media player; a user providing an input to navigate a playlist; and a user providing a subscription input.

19. The system of claim 18, wherein the social interaction includes one or more of liking the first version of the video, favoriting the first version of the video, sharing the first version of the video and commenting on the first version of the video.

20. The system of claim 14, further comprising the processor to generate a report based at least in part on values for the one or more metrics.
